(19) United States
(12) Patent Application Publication
(10) Pub. No.: US 2014/0101571 A1
(43) Pub. Date: Apr. 10, 2014

(54) Shared collaborative environment

(71) Applicant: Lucid Dream Software, Inc., Hoffman Estates, IL (US)

(72) Inventor: David Ray Lewis, Hoffman Estates, IL (US)

(73) Assignee: Lucid Dream Software, Inc., Hoffman Estates, IL (US)

(21) Appl. No.: 14/040,217

(22) Filed: Sep. 27, 2013

Related U.S. Application Data
(60) Provisional application No. 61/709,685, filed on Oct. 4, 2012.

(51) Int. Cl. H04L 29/06

(52) U.S. Cl. CPC H04L 65/403
USPC 715/753

(57) ABSTRACT

Embodiments herein provide an apparatus, program product, and method that enable a group of users to prepare creative documents individually while working in a shared collective environment. Embodiments herein provide direct visual feedback of the work related to the documents, being performed by users in the group. As each user makes edits to their document, the edits made by the user are communicated with a collaboration manager. The collaboration manager incorporates the edits into the document and displays a preview of the edited document to the active members of the collaboration group. The preview may be displayed in a window along with the current design window of each user. There may also be an alternate means of communication between the users of the collaboration group displayed.

### CROSS-REFERENCE TO RELATED APPLICATIONS

This patent application is based on and claims priority to U.S. Provisional Patent Application Ser. No. 61/709,685, filed on Oct. 4, 2012, the entire contents of which are incorporated by reference herein.

### FIELD

The present application relates, generally to networking and, more particularly, for providing on-line micro-social collaboration for a plurality of users of computing devices.

### BACKGROUND

The wide spread nature and accessibility of the Internet combined with social networks and other collaborative environments have expanded the collective base of like-minded people, irrespective of distance and location. This has given a new impetus to many traditional activities, such as scrapbooking, designing, and other design projects (such as preparing regional marketing materials, project reports and so on) by allowing people to express their creative nature through collage and design in an artistic fashion through online social and collaborative networks. These activities are greatly enhanced by a collaborative environment, where people can work on individual design projects and tap into the collective consciousness of like-minded groups to share resources and knowledge. This group activity as it relates to the scrapbooking community is generally referred to as a “Crop Event.” Crop events have a long standing history in the traditional world of scrapbooking as a gathering of people for the purpose of cutting pasting and assembling intricate books while working in the company of a group. Such events extend back to the very earliest days in history as “Quilting Events” as people would come together and each create an individual intricate design which would then be incorporated into a blanket

In the field of online commerce or ecommerce, however, websites do not provide a capability for multiple users to work on multiple individual projects in a simultaneous collective fashion.

### SUMMARY

The present application provides a system for providing on-line micro-social collaboration for a plurality of users of computing devices. In one or more implementations, one or more databases include electronic user account information representing users registered to access and participate in the micro-social collaboration. The database(s) also include electronic project information representing a plurality of projects respectively created and/or edited by at least some of the registered users. Requests to access one of the projects are received over a communication network from each of a plurality of respective computing devices operated by at least some of the registered users. The requests are processed by the at least one processor to provide a current representation of one or more project to each of the respective computing devices and to provide a communication connection for at least two of the users of the respective computing devices that are accessing their individual project to communicate with each other. Further, an edit to a project is received from one of the respective computing devices accessing the project. The received edit is processed to revise the project in accordance with the edit and to update the representation of the project. Furthermore, the updated representation of the project is transmitted to each of the respective computing devices that are including the project in their collaborative group.

These and other aspects, features, and advantages can be appreciated from the accompanying description of certain embodiments of the invention and the accompanying drawing figures and claims.

### BRIEF DESCRIPTION OF THE DRAWINGS

In order that the advantages of the present application will be readily understood, a more particular description of the present application briefly described above will be rendered by reference to specific embodiments illustrated in the appended drawings. Understanding that these drawings depict only typical embodiments of the present application and are not therefore to be considered limiting of its scope, the present application will be described and explained with additional specificity and detail through use of the accompanying drawings, in which:

FIG. 1 depicts an online collaboration system, according to embodiments as disclosed herein;

FIG. 2 depicts a collaboration manager, according to embodiments as disclosed herein;

FIG. 3 is an exemplary illustration of a screenshot of the collaboration window as viewed by a user, according to embodiments as disclosed herein;

FIG. 4 is an exemplary illustration of the process of collaboration, according to embodiments as disclosed herein; and

FIGS. 5-31 provide exemplary illustrations of the process of collaboration, according to embodiments as disclosed herein;

### DETAILED DESCRIPTION

It will be readily understood that the components of the present application, as generally described and illustrated in the Figures herein, may be arranged and designed in a wide variety of different configurations. Thus, the following more detailed description of the embodiments of the present application, as represented in the Figures, is not intended to limit the scope of the present application, as claimed, but is merely representative of certain examples of presently contemplated embodiments in accordance with the present application. The presently described embodiments will be best understood by reference to the drawings, wherein like parts are designated by like numerals throughout.

The present application has been developed in response to the present state of the art and, in particular, in response to the problems and needs in the art that have not yet been fully solved by currently available apparatus and methods.

Embodiments herein provide an apparatus, program product, and method that enable a group of users to prepare one or more creative documents individually while working in a shared collective environment. Embodiments herein provide direct visual feedback of work related to the document(s), being performed by users in the group. As each user makes edits to the document, the edits made by one user may be communicated with one or more other users using a collaboration manager. The collaboration manager substantially automatically incorporates the edits into the document and displays a preview of the edited document to members of the group. In an implementation, the preview may be displayed in a respective window with design window(s) for each user. One or more communication channels may be provided for the users of the group to communicate with one another.

Embodiments in accordance with the present application may be embodied as an apparatus, method, or computer program product, and may take the form of an entirely hardware embodiment, an entirely software embodiment (including firmware, resident software, micro-code, etc.), or an embodiment combining software and hardware aspects that may all generally be referred to herein as a “module” or “system.” Furthermore, one or more embodiments may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present application may be written in any combination of one or more programming languages, including an object-oriented programming language such as Java, Javascript, Ruby, C++, or the like and conventional procedural programming languages, such as the “C” programming language or similar programming languages. Further, the computer programming code may be written using a development tool available for developing internet enabled apps. The program code may execute entirely on the handheld device, a remote computing system or server (herein after referred to as the computing system) or partly on the computing system and the handheld device. In the latter scenario, the computing system may be connected to the handheld device through a suitable type of communication network, such as a cellular communication network, a wireless communication network and so on.

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The present application is described below with reference to flowchart illustrations and/or block diagrams of methods, apparatus (systems) and computer program products according to embodiments of the present application. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a processor-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

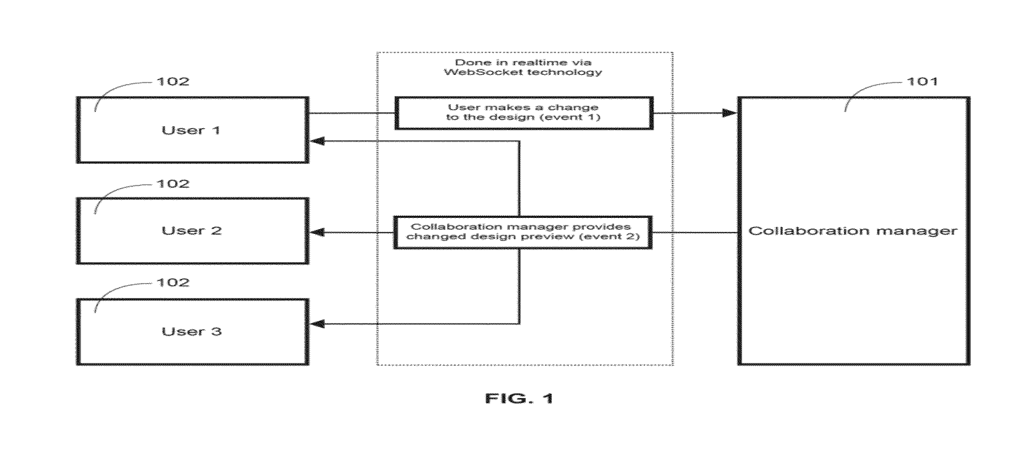

FIG. 1 depicts an online collaboration system, according to embodiments as disclosed herein. The collaboration system, as depicted herein, comprises a collaboration manager 101 and a plurality of users 102. The collaboration manager 101 and the plurality of users 102 are connected using the internet or any other suitable networking connection means (such as a Local Area Network (LAN), a Wide Area Network (WAN) and so on). The users 102 may be accessing the internet using a suitable device such as a computer, a mobile computer (such as a laptop, netbook, ultrabook and so on), a Personal Digital Assistant (PDA), a mobile phone, a tablet or any other suitable device. The users 102 may access the collaboration manager 101 using a web browser or a stand-alone web application.

The collaboration manager 101 enables the users 102 to work in a collaborative manner on any project. The project may include at least one editable format such as a text document, an image, a graphical design, a logo or a combination of one or more of the same.

The collaboration manager 101 may enable at least one user 102 to direct or otherwise manage one or more projects. The collaboration manager 101 enables users to attach projects to groups or to create new projects and join them to a new or existing group by assigning a group identifier. The collaboration manager 101 may further enable users of a group to access existing projects that include contributions from one or more group members, and may add a user to a group. Further, and as noted above, collaboration manager 101 may prepare a preview of various user contributions for preview. Further, the collaboration manager 101 receives edits as users modify or make new contributions, and quickly renders a new preview and delivers this to one or more members of a group. Thus, there may be more than one user editing a project or multiple individual projects at the same time and edits made by each of the users may be previewed by the active group members. Edits made by each user may be viewed in a single window, which may include one or more panes, corresponding to each user. In an alternative, edits made by each user may be viewed in multiple windows, wherein each user viewing the edits may arrange the windows according to his/her preference. Further, each user may be viewing and/or editing multiple projects simultaneously, with each project having a window.

The collaboration manager 101 may further enable users 102 to create groups of users. Groups may be identified by group name, user name, project identifier, or other suitable way. Moreover, groups and projects, may be secured, such as via password or other authentication.

The collaboration manager 101 may enable the user 102 to submit at least one project identifier. When submitted, the collaboration manager 101 may access the project associated with the identifier in accordance with a particular environment. For example, an open sockets channel may be used. Web Sockets may be applicable to establish a plurality of API establishing “socket” connections between web browsers and a server. This provides a persistent connection between a plurality of clients and a server and users operating the plurality of web browsers can send data at any time during a multi-user session, including as shown and described herein.

The collaboration manager 101 may also verify that the project is associated with a particular group, before transmitting the most recent preview of newly added projects to the user 102.

The collaboration manager 101 may further identify projects with recent edits and retrieve specific pages having the edits. The edits may be communicated to the collaboration manager 101 in the form of a page description. The collaboration manager 101 may further create a preview image, based on the edited page and may display the preview image to users in a respective group. The collaboration manager 101 may display the preview image by transmitting a Uniform Resource Locator (URL) of the preview image to the active users in the group. The collaboration manager 101 may further store the preview image in a suitable location.

The computing device used by the user 102 is suitable for creating a new or opening an existing project. For example, standard Internet web browser software that is configured with tools for various kinds of document editing operates on the user's 102 device. The device may be configured to communicate via an open socket channel, including to transmit current page number and edits made to the collaboration manager, which then renders previews of these edits and transmits these updated previews back to a special group preview panel of all group projects currently open by other active group users.

Furthermore, the computing device used by the user 102 may subscribe to an open group socket channel and request and receive page layout descriptions of a selected page for display, editing, and transmitting edits through the group socket channel. The device may load the current page previews from other online group users 102, and display and update recently edited pages of other design projects currently open by other users 102 in the group. Further, the device may support communication between users 102 via a suitable method, such as chat, video, audio and a combination of one or more of the methods through the socket.

The collaboration manager 101 further may store projects. Projects may be tagged with at least one of: project identifiers; a user identifier; a page layout description; an identifier of the most recently edited page; and/or a preview image of each page of the project. The page layout description may include any number of pages in the project, as well as, information about design elements and respective placements in each of the pages. Other transformational metrics of various types of content making up an overall design may also be stored.

The collaboration manager 101 may also store account information for users 102 that includes an account identifier for each of the users 102, online/offline status of the respective users 102, the respective permissions accorded to each user 102 and the projects for each user 102.

In another embodiment, the collaboration manager 101 may enable any user to access and/or edit a project. The collaboration manager 101 may also provide preview images of edits to other users 102 editing the same project.

After a user 102 changes a design (referred to as event 1), the event is communicated to the collaboration manager 101 substantially in real time using a suitable technology such as WebSocket.

The collaboration manager 101 further provides the changed design preview to the users 102 substantially in real time, who are part of the group (referred to as event 2). The collaboration manager may provide the preview to the users 102 using a suitable technology such as WebSocket. The changed design preview may be provided to the users 102 in one or more preview windows.

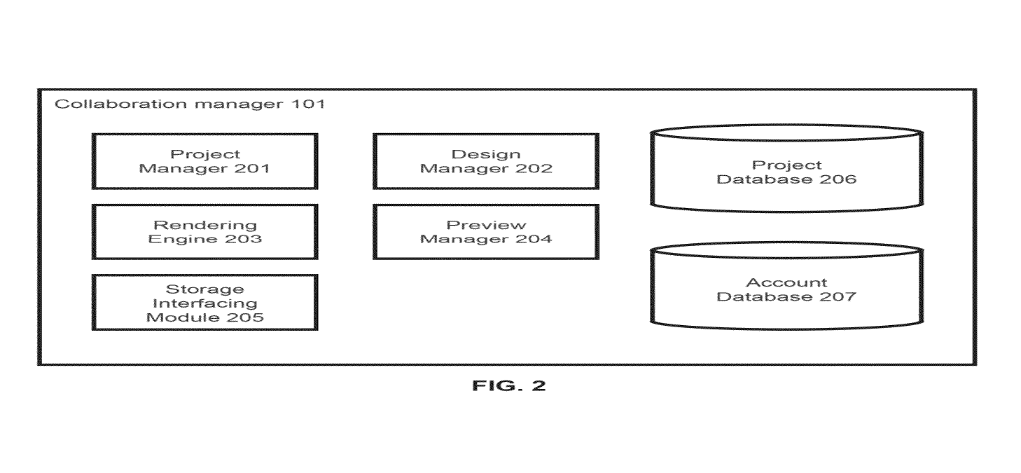

FIG. 2 depicts a collaboration manager, according to embodiments of the present application. The collaboration manager 101 as shown in FIG. 2 includes a project manager 201, a design manager 202, a rendering engine 203, a preview manager 204, a storage interfacing module 205, a project database 206 and an account database 207.

The project database 206 store projects and their related information. Each of the projects may be tagged with at least one of project identifiers, at least one user identifier, a page layout description, the identifier of the most recently edited page and a preview image of each page of the project. The page layout description may include of any number of pages in the project, information about the design elements and their respective placements in each of the pages or the like.

The account database 207 may store account information for users 102, that includes account identifier for each of the users 102, online/offline status of the respective users 102, the respective permissions accorded to each user 102 and the projects and group associations for each user 102.

The project manager 201 may enable users 102 to create and remove projects, update and close events related to projects, and assign a group identifier for any project.

The project manager 201 may further enable users 102 to login to their account(s) using at least a user name and password. The project manager 201 may also enable the user to create an account by registering a user ID. In another embodiment herein, the user 102 may also enter a password.

The project manager 201 may display a list of all projects owned by a user 102 and display a preview of each project along with a reference to any group to which each project may belong.

The project manager 201 may further identify projects with recent edits and retrieve the specific pages with the edits. The rendering engine 203 may create a preview image, based on the edited page, and the preview manager 204 may display the preview image to the users in the group. The preview manager 204 may display the preview image by transmitting a Uniform Resource Locator (URL) of the preview image to the active users in the group. The project manager 201 may enable more than one user to edit a project at the same time and enable edits made by each of the users to be previewed by the active group members. The project manager 201 may enable edits made by each user to be viewed in a single window, wherein the single window comprises of a plurality of panes corresponding to each user. The project manager 201 may further enable edits made by each user to be viewed in multiple windows, and users may arrange the windows according to preference. Further, the project manager 201 may enable each user to view and/or edit multiple projects simultaneously, with each project having a window. The project manager 201 may further store the preview image in the project database 206.

In another embodiment, the project manager 201 in association with the design manager 202 may enable multiple designs as a possibility for each project. For example, a project for a book, wherein the project has separate designs for the contents of the book separate from the cover of the book and opening any of the associated designs will result in active group status for the project.

In another embodiment herein, the preview image may be in the form of a video or any type of activity streaming displaying the changes made by the user in a live manner.

In another embodiment herein, the collaboration manager 101 may be configured in various distributed modules, wherein the modules may be co-located or be in various locations.

In another embodiment herein, the collaboration manager 101 may be implemented in the “cloud,” and modules of the collaboration manager 101 may operate via a plurality of servers, which may be co-located or be located in various locations and connected using a suitable connection means.

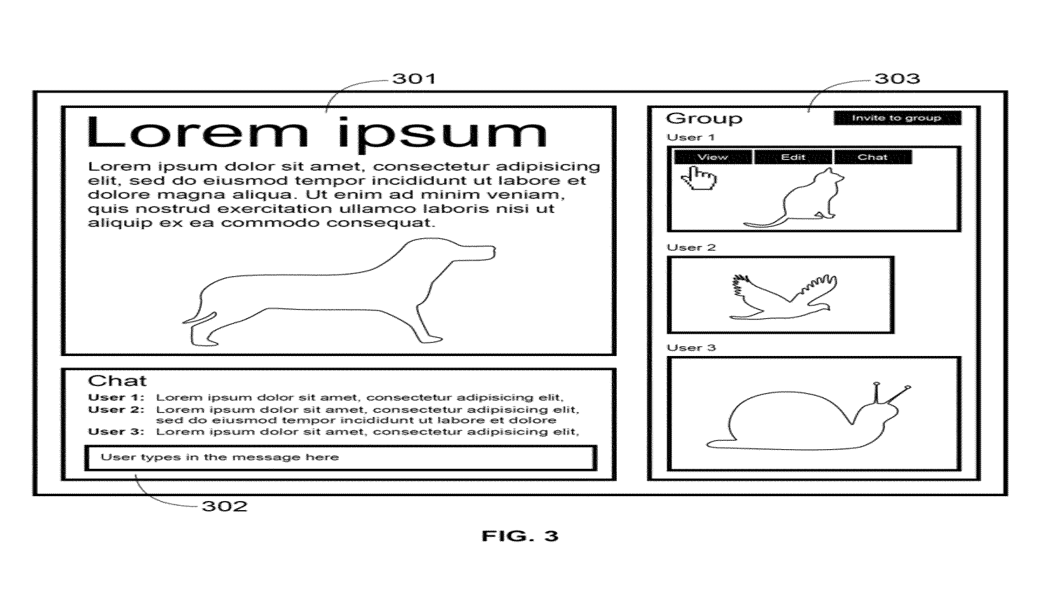

FIG. 3 is an exemplary illustration of a screenshot of the collaboration window as viewed by a user, according to an embodiment. The collaboration screen comprises of a plurality of canvasing such as an editing window 301, a communication window 302 and a preview window with a plurality of previews 303. The collaboration screen may be viewed by the user 102 using a browser or a stand-alone application.

The editing window 301 enables the user 102 to edit the project designs. The editing window 301 may further provide online design tools to enable design editing. The preview windows 303 generates the group view window to display the various group project previews and maintain the group functions for preview update. Each of the previews may provide further options enabling the user 102 to view and edit the preview. Each of the previews may further provide an option for the user 102 to interact with other users corresponding to each preview, wherein the interaction may be in the form of text chat, voice chat or any other suitable form. The previews may be displayed using a suitable image format such as JPEG, PNG, TIFF or other format. The communication window 302 may be used for communication between the users in the group. In another embodiment herein, the communication window 302 may be used for communicating with other users 102 who are editing the same project. In another embodiment herein, the communication widow 302 may be used for communicating with one other user at a time. The collaboration screen also offers remote design functions for opening other projects.

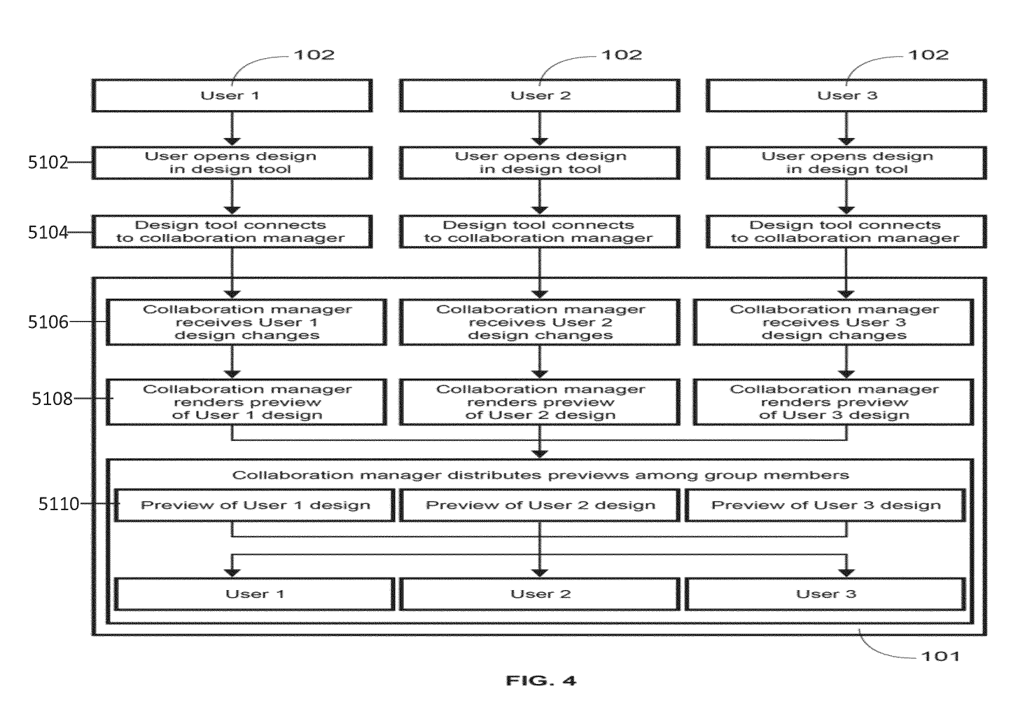

FIG. 4 is an exemplary illustration of the process of collaboration, according to embodiments as disclosed herein.

A plurality of users 102 open design projects using a design tool. The design tool may be an application present on the device of the user 102. The design tool may also be an online application, accessed by the user 102 using a suitable means such as browser. In an embodiment, user 102 may make changes to a project using the design tool. The changes made by the user 102 may be communicated to the collaboration manager 101 using a suitable technology such as WebSocket. On receiving the changes made by the user 102, the collaboration manager 101 renders a preview image of the changes. The collaboration manager 101 may render the preview as an image using a suitable format. The collaboration manager 101 then may distribute the rendered image as a preview to all the group users.

Consider an exemplary implementation of the embodiments as disclosed above in an online design environment for scrapbooks. A user creates a scrapbook design by using the online browser based design tool, for example by uploading content for the scrapbook. The user may also select a template for a scrapbook from a suitable location. On opening the design tool, a connection is made with a server, via a socket channel. A review group of users collaborating with the user on the scrapbook access one or more web pages that may include a preview window 303, which appears in a “masonry” style and loads active user projects in panels sized to correlate with the scrapbook size. Each panel loads both a preview of their current version of the scrapbook and an individual chat window corresponding to one or more users. As users make changes to the scrapbook, the same changes are updated in the preview image in a moderator panel through the project manager 201 preview render and replace mechanism. Each preview window will have options to remotely control various aspects of the users online design tool, including the option to open their design in a local design tool and to be able to interact live with the users working on their project.

Consider an exemplary implementation of the embodiments as disclosed above in an online design environment. A design group user creates a business card design by using the online browser based design tool. On opening the design tool, a connection is made with a server via a socket channel. A review group of web site administrators or others provided with special access enabled by the site administrator access a moderator admin page, that opens a preview window done in a “masonry” style, which includes active design group user projects in panels sized to correlate with the product size. Each panel loads both a preview of current work and an individual chat window. As design group members make changes to the project the preview image updates in the moderator panel through the Project Manager 201, which provides a preview render and replace mechanism. This enables the review group members to monitor large numbers of design group members with minimal traffic and overhead requirements. Review group members have the ability to see the product type, preview, date-time, user info, and interactive chat. Each preview window may have options to remotely control various aspects of the users online design tool, including the option to open designs in a local design tool and to be able to interact live with the user working on a project.

In another embodiment, consider a business made up of remote business units where each unit is responsible for the design and production of advertising materials relevant to their region or segment. By working in multi-user multi-design collaborative environment, all units may contribute to the entire company creativity, while focusing on the needs of their business unit. Also, the central business management can maintain an overview of all design projects.

Embodiments herein address a need to enable a dynamic group of users to form and share individual artistic capability and resources in a collective fashion while using online networked tools.

This “near to live” update process as disclosed in embodiments herein, enables users to share creative ideas and enhances the overall creativity of all group members. The enhanced creativity and the inspiration of seeing group members design activity functions adds an additional motivation resulting in group members completing their design project faster and with more confidence. This effect also results in higher conversion of design projects to actual online orders.

Embodiments herein provide a mechanism for enabling multiple users to work in a collaborative fashion on multiple designs. Embodiments herein also provide the ability to see near to live updates of each user edits by all other users and do so in an internet connected environment with reduced bandwidth requirements based on a centralized server method of quickly rendering these edits and delivering them to each group member as images.

The block diagrams and illustrations in the FIGS. 1, 2 and 3 illustrate the architecture, functionality, and operation of possible implementations of systems, methods, and computer program products according to various embodiments of the present application. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figures. In certain embodiments, two blocks shown in succession may, in fact, be executed substantially concurrently, or the blocks may sometimes be executed in the reverse order, depending upon the functionality involved.

The present application may be embodied in other specific forms without departing from its spirit or essential characteristics. The described embodiments are to be considered in all respects only as illustrative, and not restrictive. The scope of the present application is, therefore, indicated by the appended claims, rather than by the foregoing description. All changes which come within the meaning and range of equivalency of the claims are to be embraced within their scope.

The present application is further described as follows:

Micro Social Collaborative Design Studio

Highly creative design projects, such as Photo or Scrap Books, can greatly benefit when worked on in small groups where group members can gain inspiration and increased productivity by sharing ideas and viewing each other's work in progress in these social settings. The Micro Social Collaborative Design Studio, in accordance with an embodiment, provides the tools and features to enable social collaborative design groups to form, inspire, produce, and disband, without regard to geographic location of members of the group.

The Micro Social Collaborative Design Studio—or MSCDS for short—may be configured as computer software developed to work in a networked or cloud environment, and may include one or more of the features described below.

The Project Manager may be developed using technologies such as Ruby on Rails and MYSQL, the Project Manager is a centralized server or cloud based system that both manages user accounts and design projects. User accounts enable people who visit the system to create, edit, and delete personal accounts. Design projects are typically, but not limited to, product oriented user designable projects and may consist of numerous sub-components, such as a Scrapbook which may include a component for the pages of the book, another component for the cover of the book, and additional components for items like a slipcase or a dust jacket. Together the user and components for a specific product make up a Project.

The Social Networking Manager may be developed using technologies such as Ruby on Rails, the Social Networking Manager is a centralized server or cloud based system. The Social Networking Manager provides tools in the form of web based methods for users to be able to perform actions such as listing or searching for Micro Network Groups based on a variety of criteria such as themes, size, users and more. It enables users to be able to invite other users to join existing Micro Network Groups or to join groups they have created, found, or been invited too by attaching a Project to the group.

The Collaboration Manager may be developed using technologies such as AMQP messaging, Comet, and NodeJS, the Collaboration Manager provides the live connectivity functions to make Collaborative Design possible. The Collaboration Manager may establish and maintain an always open connection channel—or “Socket” for each active Micro Network group. Each user Design Studio instance may “subscribe” to the designated channel/socket as established by the Social Networking Manager for the specific “joined group” for the currently open User—Project—Component. The Collaboration Manager may send and receive messages using either the channel/socket with the Design Studio, or using a standard messaging system with the various server side Design Processors that perform work.

The Design Studio may be developed using technologies such as JavaScript, the Design Studio is a web application that may create a visual user experience when run as part of an internet connected web browser for each User—Project—Component. The Design Studio performs two most basic functions, providing the tools and features similar to existing design tools such as the popular Adobe Photoshop which enable the user to combine art, graphics, text and more into an artistic creation; and second to enable the Social Collaboration Preview Window features enabling users to experience the social sharing of design, inspiration, criticism, and communication that is critical to maintaining the Micro Network group.

The Design Processors developed using technologies such as AMQP messaging, C++ and Java the Design Processors receive messages from the Collaboration Manager to perform various work units which give work results that are then transmitted back to the Collaboration manager. Design Processors are used in various ways such as to prepare uploaded art to a form compatible for use in the Design Studio and to prepare final Project Component designs into forms suitable for production printing such as PDF. One highly critical function of Design Processors is Social Collaboration Preview Rendering. The Collaboration Manager may receive Page Layout Descriptions of modified pages from the Design Studio. These single page descriptions are then sent to the Preview Rendering Design Processor which quickly renders a version of the page to a format that can be displayed by the Design Studio Social Collaboration Preview Window and then returns this Design Preview back to the Collaboration manager.

In a typical case a plurality of users may start by creating a User Account with the Project Manager. Next they would create a new Project based on some designable Product—or any kind of design event could be used in place of Products depending on the nature of use of the present application. Once a Project is created the user can attach the project to a Micro Network Group by creating a new group, responding to invitation of existing group, or requesting inclusion to a found group, using features of the Social Networking Manager.

Once attached and until the user removes the project from the group, when a user opens any component of the project in the Design Studio a channel/socket connection may be made with the Collaboration Manager which may designate the project with an Active Status. The Collaboration Manager may send a message to all Active subscribers to this specific Group channel/socket causing all Active Users Design Studio to add an entry to the Social Collaboration Preview Window for this user and to load any current Design Preview should one exist.

When the User Project Component is updated in the Social Collaboration Preview Window of all Active Users Design Studio then several actions can be taken by any Active User that may include:

Contribute to the design of the currently open component. This includes using the Design Studio artwork tools to add or edit any artistic element in the current design layout area or page. Such actions result in changes to the Page Layout Description of the currently referenced layout area or page. When individual actions are completed, or after some short predetermined time period has passed, as defined by the Collaboration Manager settings, the Design Studio may transmit the modified Page Layout Description of the current layout area or page to the Collaboration Manager which then forwards to Preview Rendering Design Processor and receives back an updated Design Preview which is transmitted to all Active User Design Studio Collaboration Preview Window.

Contribute to the design of another Active User Project Component. This involves activating the Edit URL link associated with the specific Active User Collaboration Design Preview panel. This action may either open the designated User Project Component in the Design Studio while minimizing the current Users Project Component or open a separate Design Studio window with the designated User Project Component. Once opened in this fashion, either user can contribute to the design of the project, resulting in modified Page Layout Description first transmitted to the Collaboration Manager and then in turn transmitted back to the Design Studio of other users with the same Project Component open. The Design Studio may then execute these received Page Description Modifications and update the design to reflect changes made by others. All Active Users also receive updated Design Previews.

Engage in an act of communication with the group or a specific Active User. Communication can take the form of various technologies including simple text based chat, live audio streaming, or live video/audio streaming. Such communication data is collected into packets by the communication routine of the Design Studio and transmitted through the channel/socket to the Collaboration Manager which then stores and directs the data back to the specific Active User or the entire Group as designated by the use of the communication routine.

Close and leave the Active User Group. This action of closing the Design Studio may result in a message to the Collaboration Manager which may then close the channel/socket for this User and send a notification message to the Design Studio of Active Users to remove the Collaboration Preview of the exiting user.

Examples of Use

In the field of online social networking, connections may be made on permanent basis around individuals instead of events. Design sharing events such as the previously described scrapbooking Crop event are short lived networks based on the project and subject or theme relevance rather than long term connections and such connections may typically dissolve at the conclusion of the event.

The present application provides for enabling a group of users to easily find “active” design “parties” whom they can easily join to prepare creative expressions individually, while working in a shared collective social network that automatically dissolves at the conclusion.

A web site such as www.photoalbum.com provides the user experience enabling a plurality of visitors to interact with each other. These interactions can start from the ability to see activity based on the Social Networking Manager and the Collaboration Manager components. These are manifest in a “What's Happening Now” listing of current group design projects that are actively in use at the moment. This is further enhanced by the ability to display the Design Processor Design Preview of live or near to live actions happening in the group. This completely new concept causes the visitors to not only quickly become entranced with the live activity, but to also quickly find group projects that match their interest and to then join the selected group.

Once a member of a Collaborative Design Group the user experiences the strong motivation, caused by the peer group activity, to devote a greater amount of time and effort into their design project than might normally be the case with individual design. The communication capability of the Collaboration Manager allows users to provide guidance and inspiration to each other. Additionally users can actively assist other users using the Design Studio with Collaboration Manager ability for multiple users to actively work on the same design at the same time. This enables the kind of sharing of artwork content and layout techniques that are central to the traditional physical Crop Event.

Benefits of this capability extend beyond those described above for the group design members, to the website owners. One of the most common problems for ecommerce sites using online design capability for the purpose of promoting the sale of personalized products such as (but not limited to) Photo Books is the very high percentage of unfinished projects that are never converted to orders. The Micro Social Collaborative Design Studio solves this problem in a number of ways. Design projects are left unfinished for many reasons. One user might not finish a project due to technical questions about how their design idea can be accomplished, with the MSCDS this user is able to quickly get answers from group members. Another user might abandon a project due to a lack of creative inspiration or a feeling of dissatisfaction with their work, with MSCDS users gain both creativity and pride from the direct feedback of their peers. Yet others might leave partially complete projects due to boredom or the tedious nature of completing such intricate work and subsequent mental exhaustion, with MSCDS users receive a higher level of motivation to finish projects and additionally since a project is required to join a group the mere desire to be part of the group results in ongoing project activity. All of these benefits lead to higher levels of project completion and completed projects result in higher levels of product orders.

Additional examples of MSCDS usage.

There are many circumstances where MSCDS can provide additional benefits. One example is the use in an “IntraNet” environment such as might be the case with a multi-national or regional company. Each divisional sub-unit in the company might be responsible for preparing artistic content while other executive units might be responsible for overseeing that such content meets corporate guidelines. Using MSCDS productivity in content creation is much greater due to the fast feedback and sharing, while at the same time another aspect of the Collaboration Manager enables the executive unit to “View” a masonry style layout of the activity of the divisional units in a passive fashion. At any point the executive unit has the ability to become actively involved as needed by either utilization of the communication tools or to become a multi-user participant of a project.

In a similar fashion as described above, one of the problems common to ecommerce sites involving personalized design such as online commercial printing companies, screen printing companies such as T-Shirt or Sign printers, or any site utilizing client design as part of the order process—is the conversion rate between visitors and those that place an actual order. Current tools for such sites are very limited in regards to ways for site administrators to interact with site visitors, simple chat functions being the best case.

Using MSCDS site administrators can use the Collaboration Manger ability to provide a layout view of current active visitors enabling the administrator to easily determine if a user might need help and to proactively offer assistance. This layout view is provided in what is termed a “Masonry” style along the lines of “Bricks in a Wall”. Each “brick” represents any given active users current Design Preview and can also include along with the Design Preview a variety of additional links to various tool sets, such as a link to open the design in the Design Studio, the ability to open a larger preview for closer observation, the ability to remotely activate various functions in the remote users Design Studio application such as save or build final print ready PDF, and also access to communication tools such as chat.

These heretofore unavailable features improve the conversion of visitors to orders and enhance competitive advantage.

A discussion is now provided with further reference to the figures.

Users join and work with groups, and users create and work with projects.

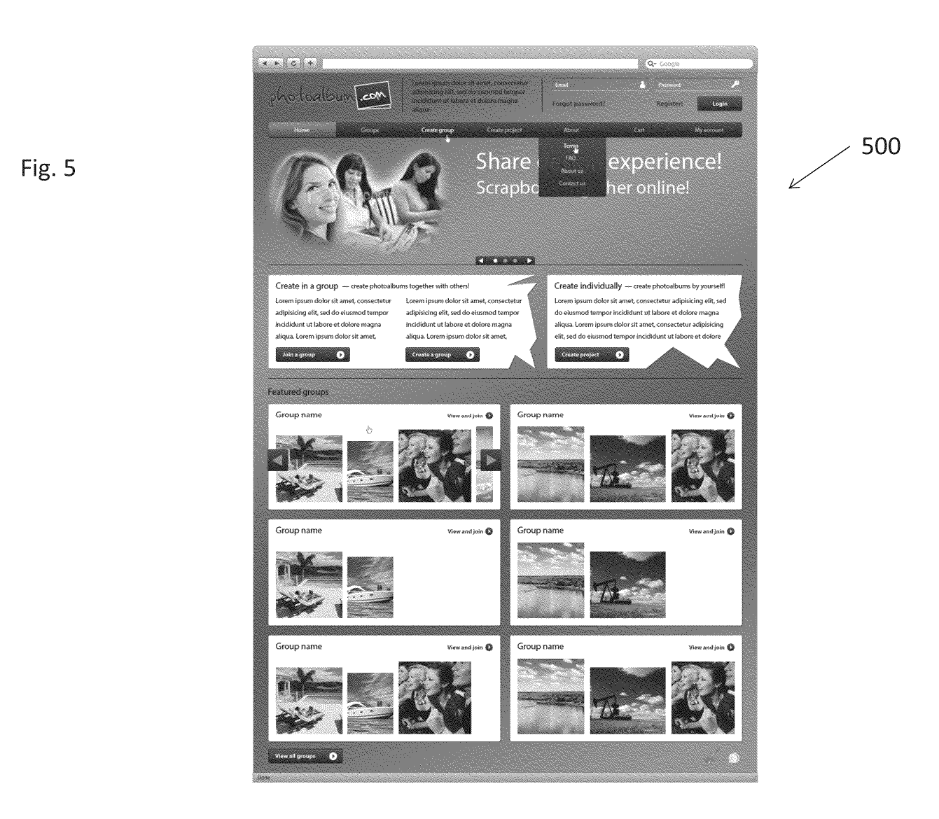

FIG. 5 illustrates an example display screen 500 for how the Social Networking Manager displays examples of Micro Network Groups in a fashion to entice involvement by simple visitors to the main website.

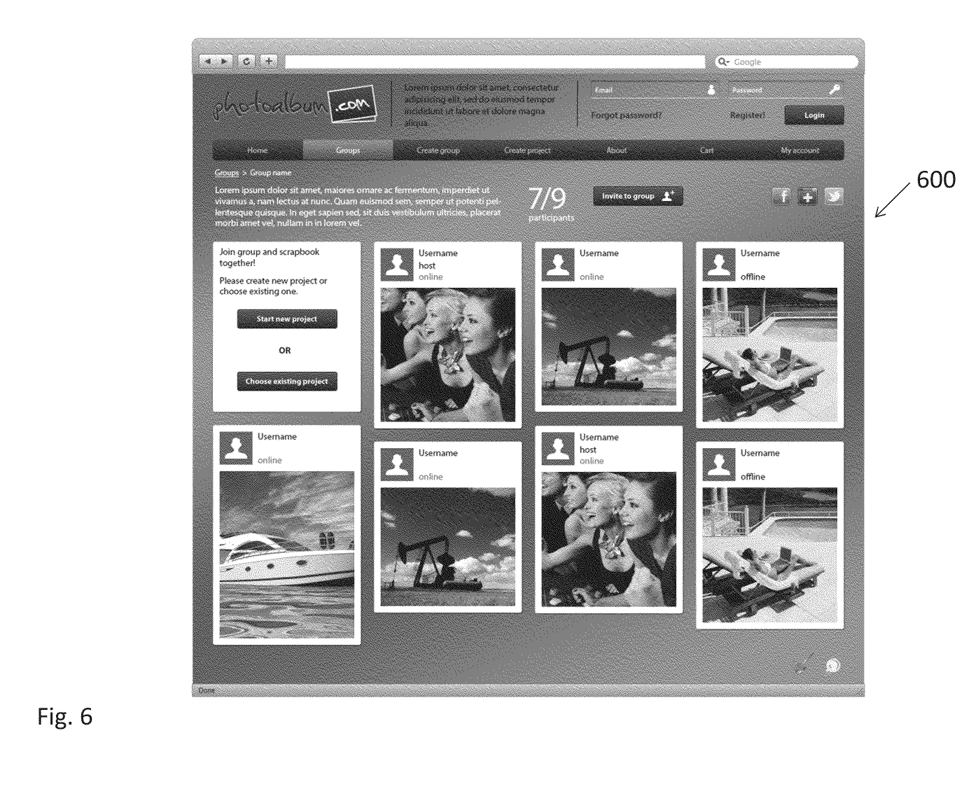

FIG. 6 illustrates an example display screen 600 that expands on the Micro Network Group function. In this example the Social Networking Manager retrieves the Users and Design Projects associated with a specific Micro Network Group using the Project Manager interface and displays this.

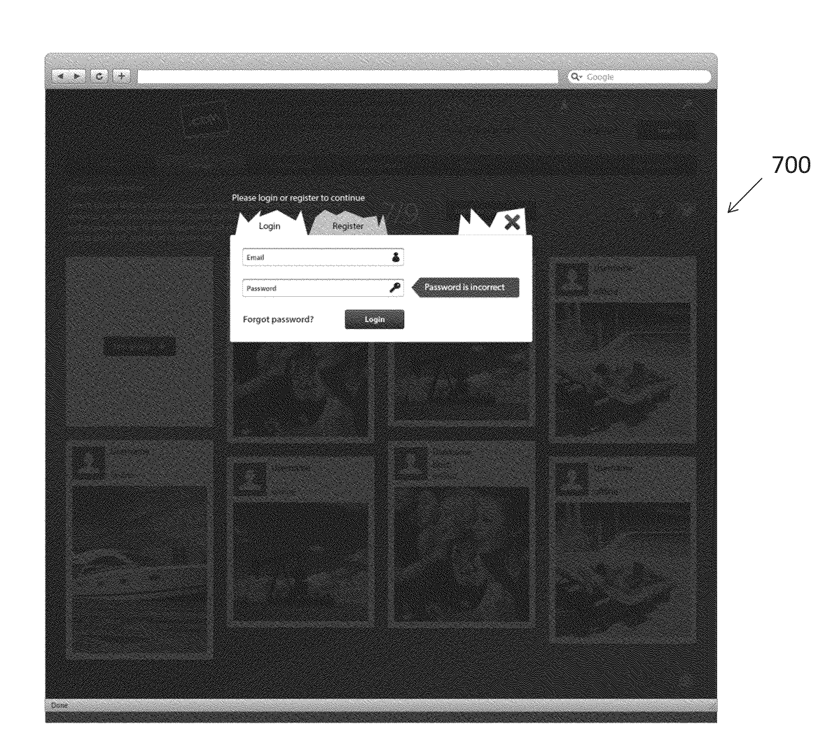

FIG. 7 illustrates an example display screen 700 for how the Project Manager is used to enable Users to access their accounts.

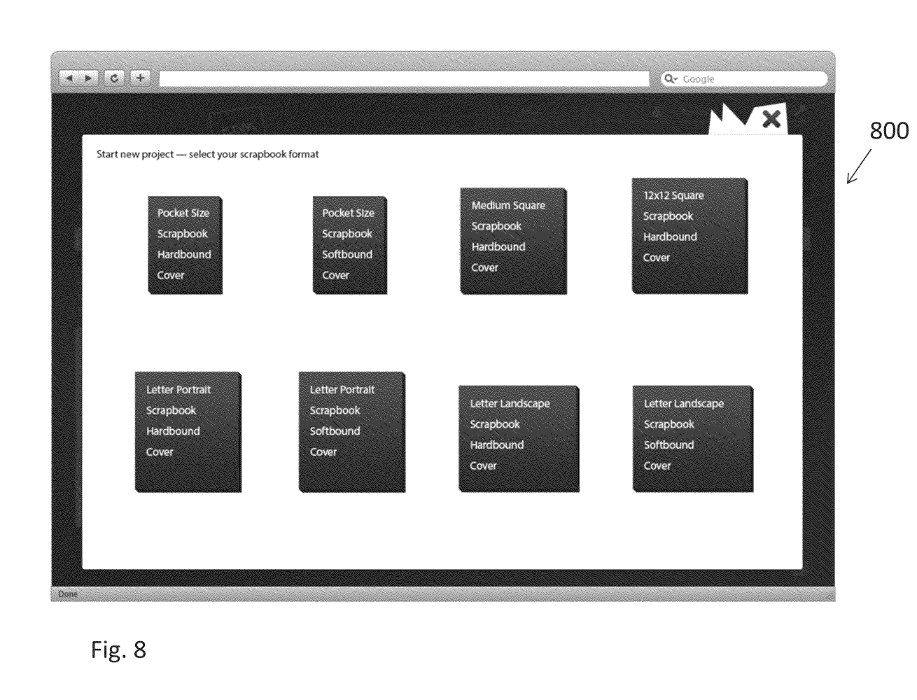

FIG. 8 illustrates an example display screen 800 for how the Project Manager is used to display various Project/Product offerings to enable Users to create new Design Projects based on the designable product and components.

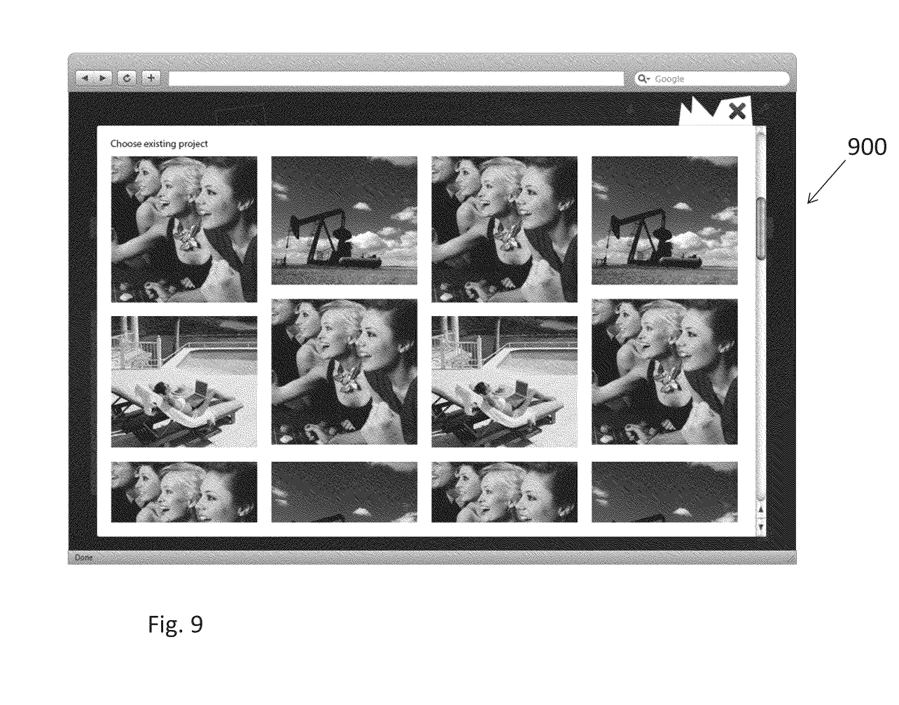

FIG. 9 illustrates an example display screen 900 for how the Project Manager enables Users to select specific Design Projects for inclusion to a specific Micro Network Group. Design previews are created using the Design Processors.

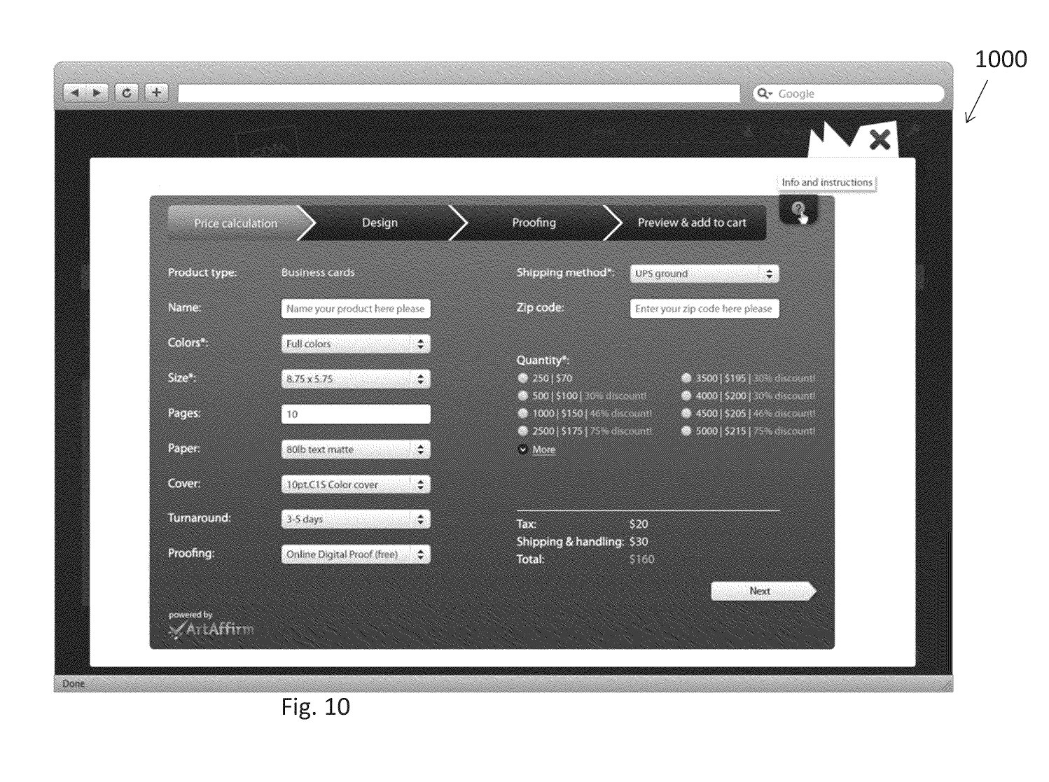

FIG. 10 illustrates an example display screen 1000 for how the Project Manager provides options to enable the User to manage the options which control the Product and sub-component options.

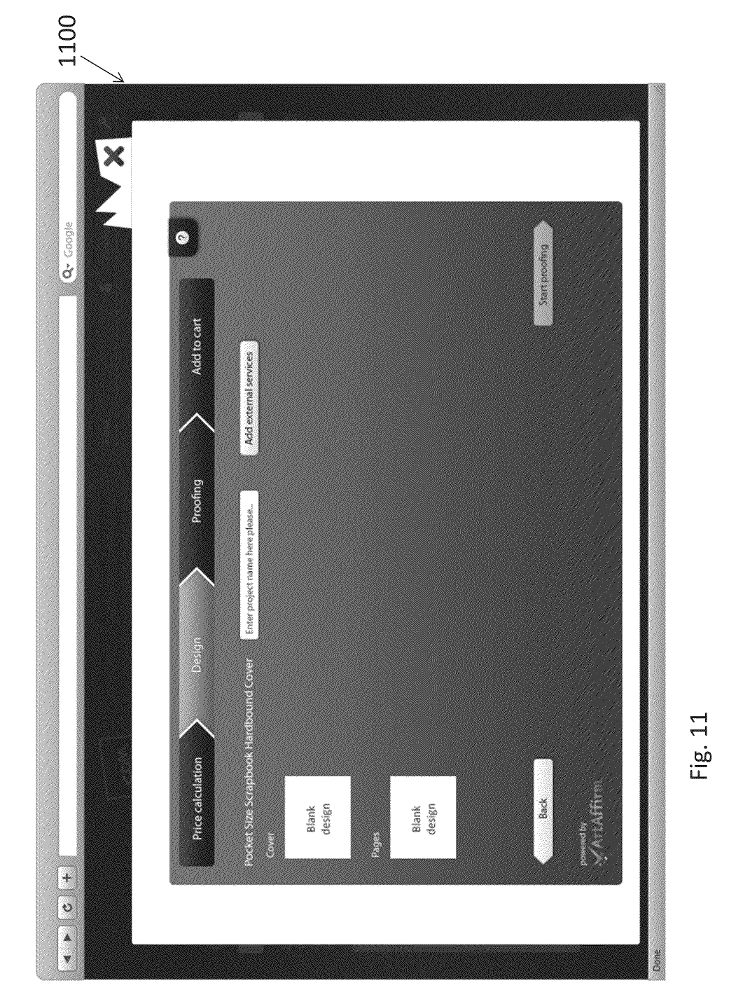

FIG. 11 illustrates an example display screen 1100 for how the Project Manager enables the User to access the Design Studio for each Project Component.

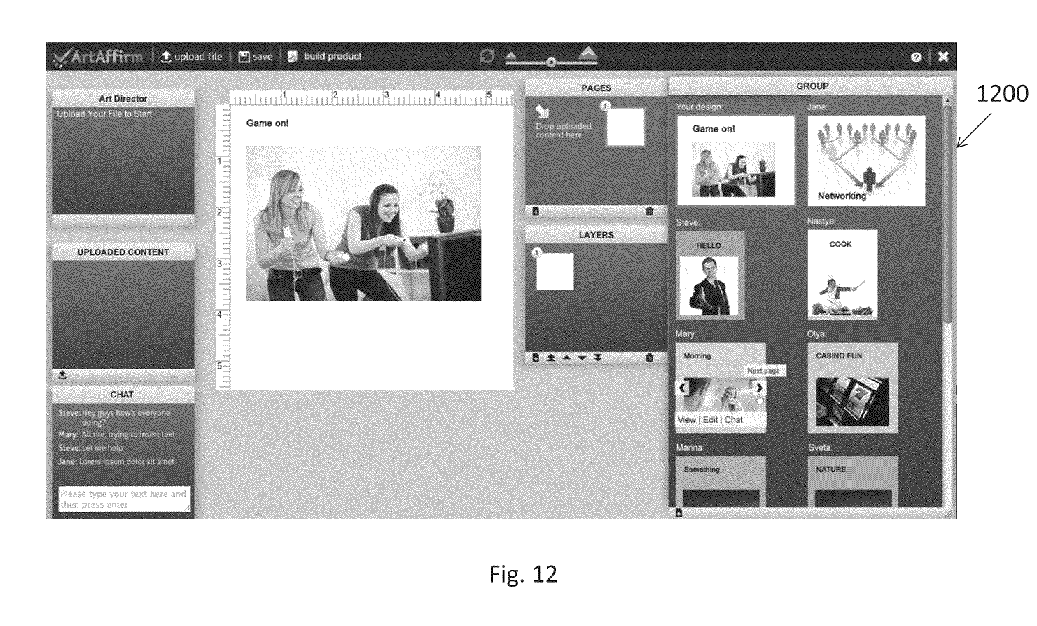

FIG. 12 illustrates an example display screen 1200 for working on a Design Project using the Design Studio. The Group preview window of the Design Studio is connected to other live Users via the Collaboration Manager as is the Chat window. Layout changes made to the central page layout design area are transmitted back to the Collaboration Manager where they are then directed to the Design Processor which generates an updated Design Preview. The updated Design Preview is then returned back the Collaboration Manager which in turn notifies the Group preview window of the Design Studio to reload or refresh the updated User Design Preview, thus enabling all Micro Network Group members to view and see changes made by each other in a near to live time-frame.

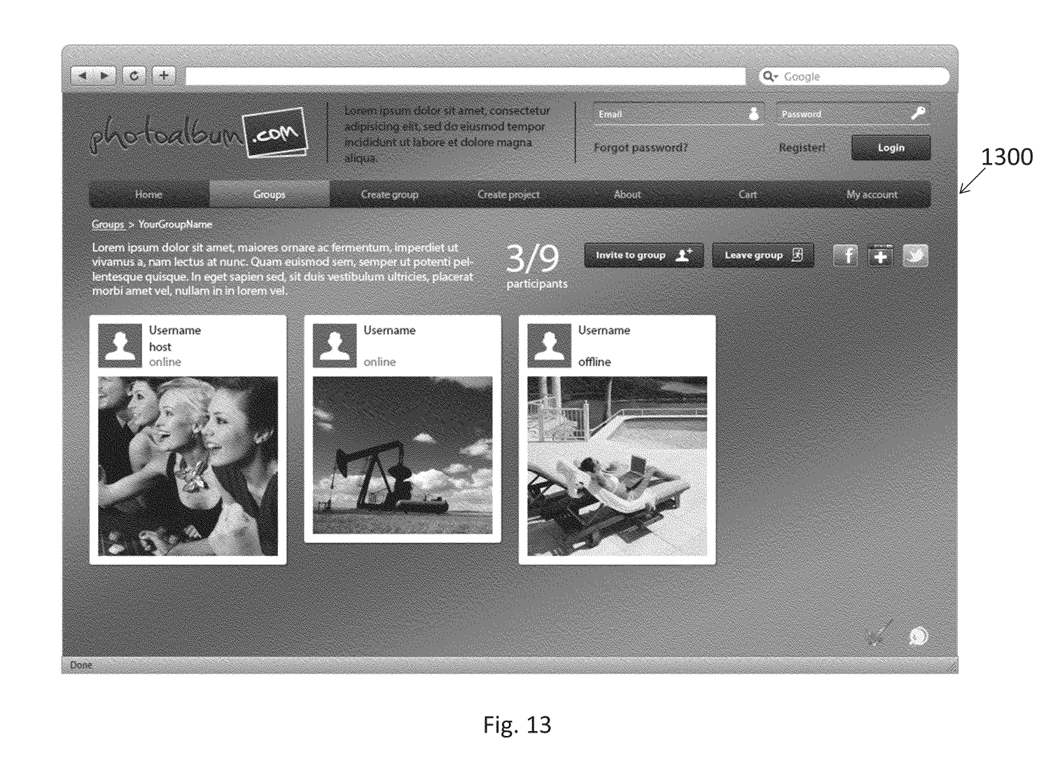

FIG. 13 illustrates an example display screen 1300 for using the Social Networking Manager for managing aspects of Micro Network Groups including inviting others to join, adding or removing projects.

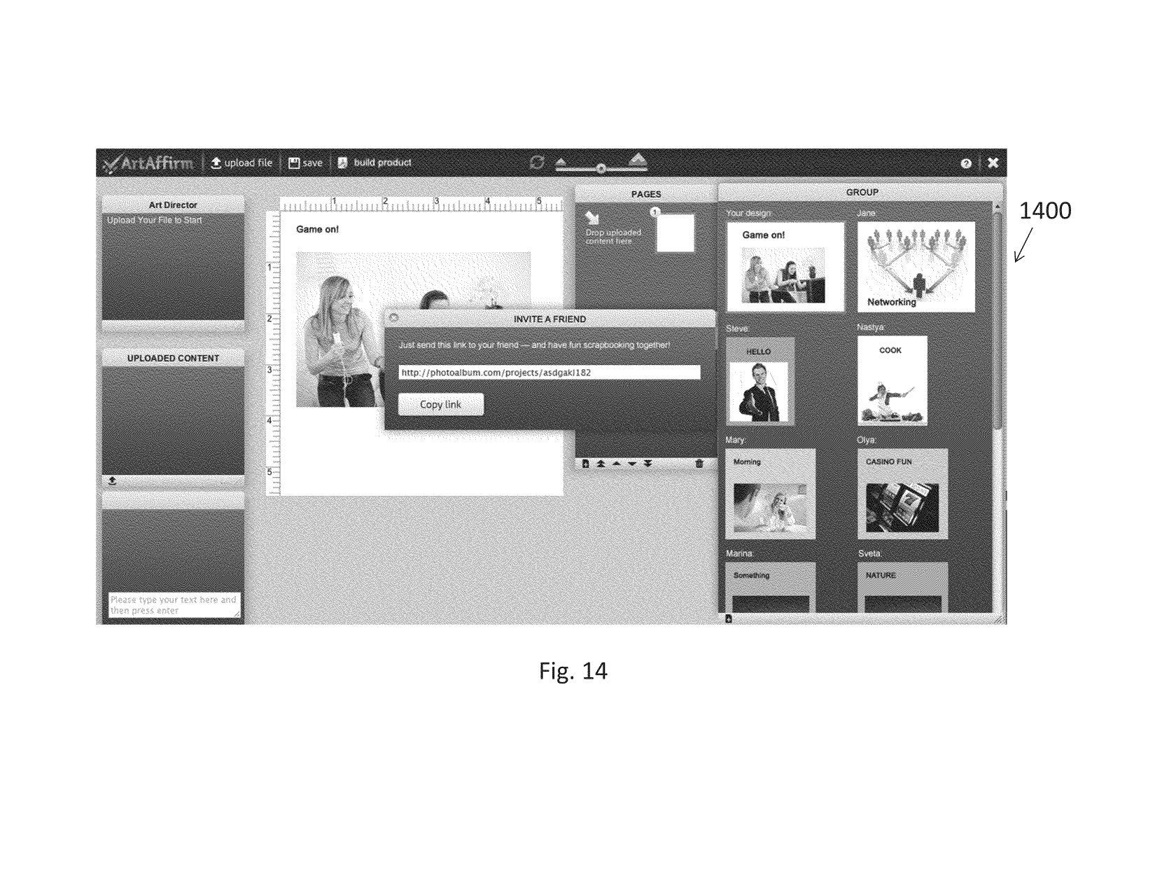

FIG. 14 illustrates an example display screen 1400 for how the Design Studio connects via the Collaboration Manager to the Social Networking Manager to enable User to invite other users while still working.

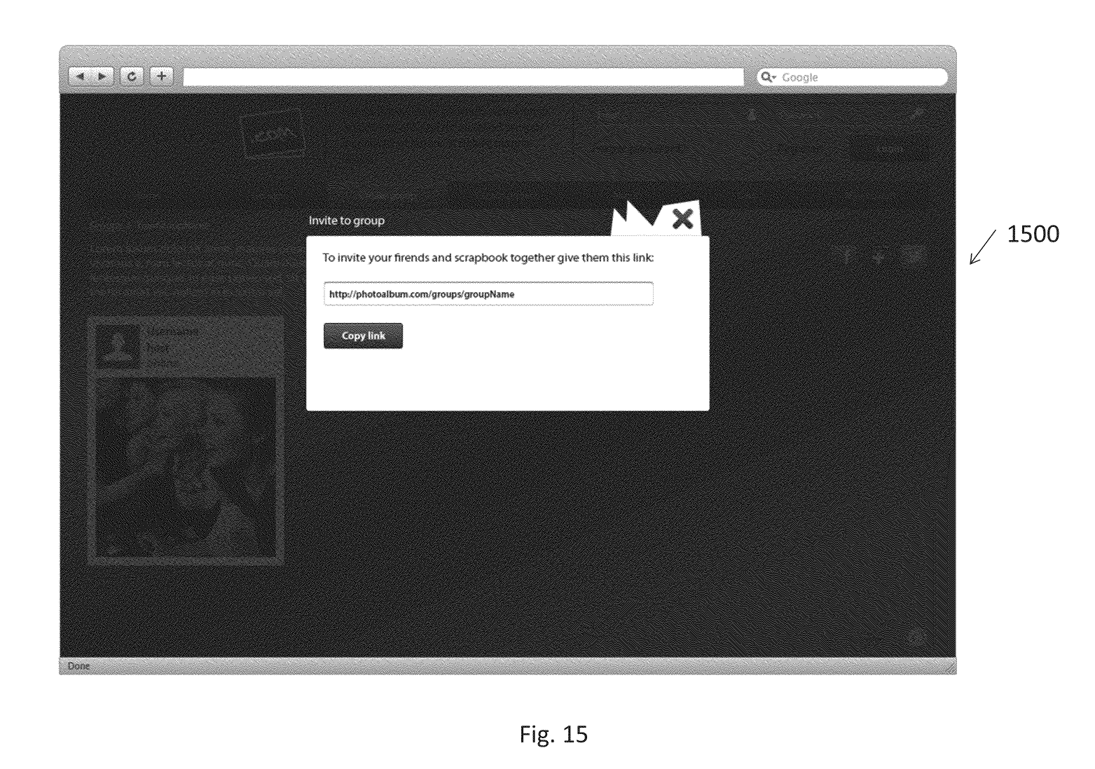

FIG. 15 illustrates an example display screen 1500 for how the Social Networking Manager generates the specific URL to enable Users to invite other Users to join any specific Micro Network Group.

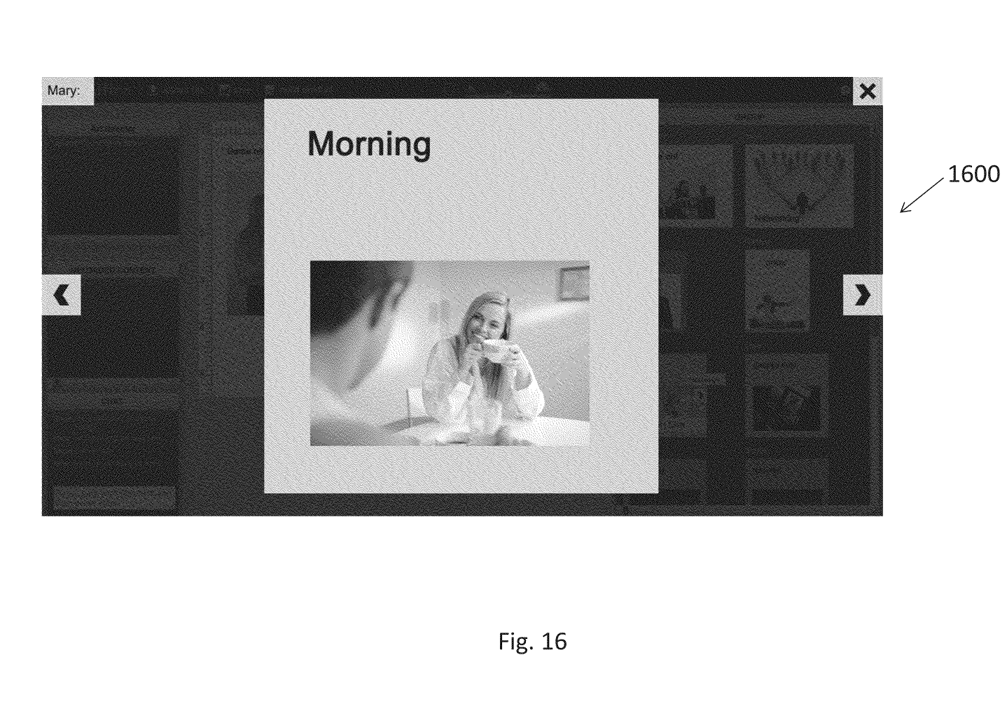

FIG. 16 illustrates an example display screen 1600 for how the Social Networking Manager communicates with the Project Manager to display the most recent Design Previews as prepared by the Design Processors.

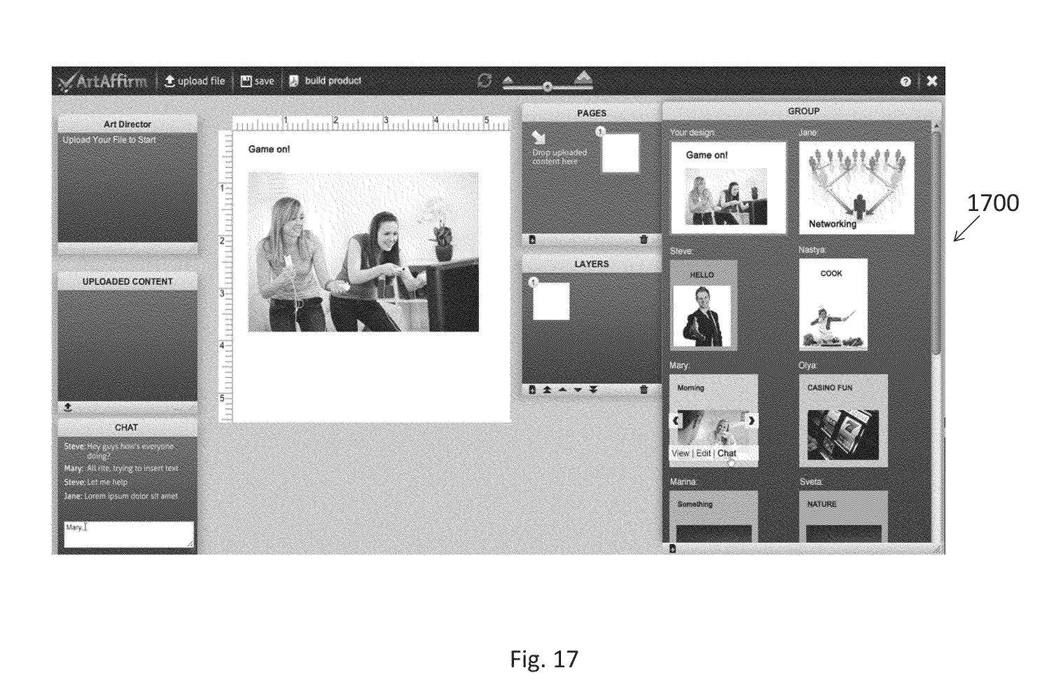

FIG. 17 illustrates an example display screen 1700 for how the Design Studio interfaces with the Collaboration Manager through the Open Connection Channel to enable the Messaging System that allows various forms of live communication between Micro Network Group Users.

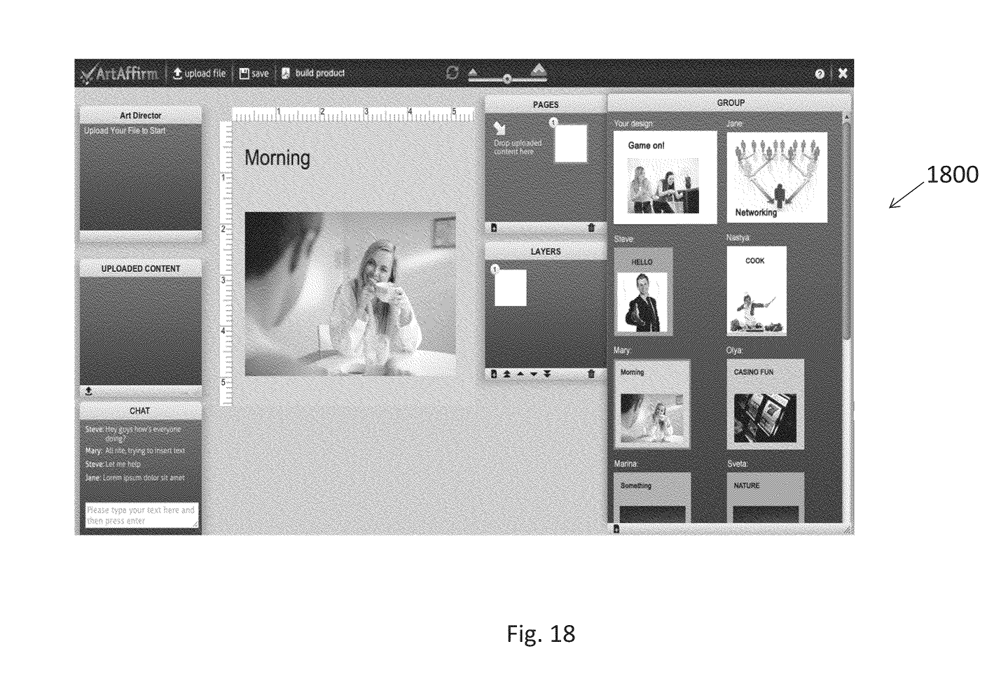

FIG. 18 illustrates an example display screen 1800 for how the Design Studio interfaces with the Collaboration manager through the Open Connection Channel to directly open another Group Users Design Project for live editing in the Design Studio. Changes made by any live editor are transmitted via the Collaboration Manager to all other editors, this includes messaging to “lock and unlock” elements that are being manipulated by one user to prevent other users from editing the same element. Modification events are first transmitted to Live Editors and then transmitted to Design Processors to update Design Previews which are then updated in the Group Preview window of all users.

Group Creation Figures

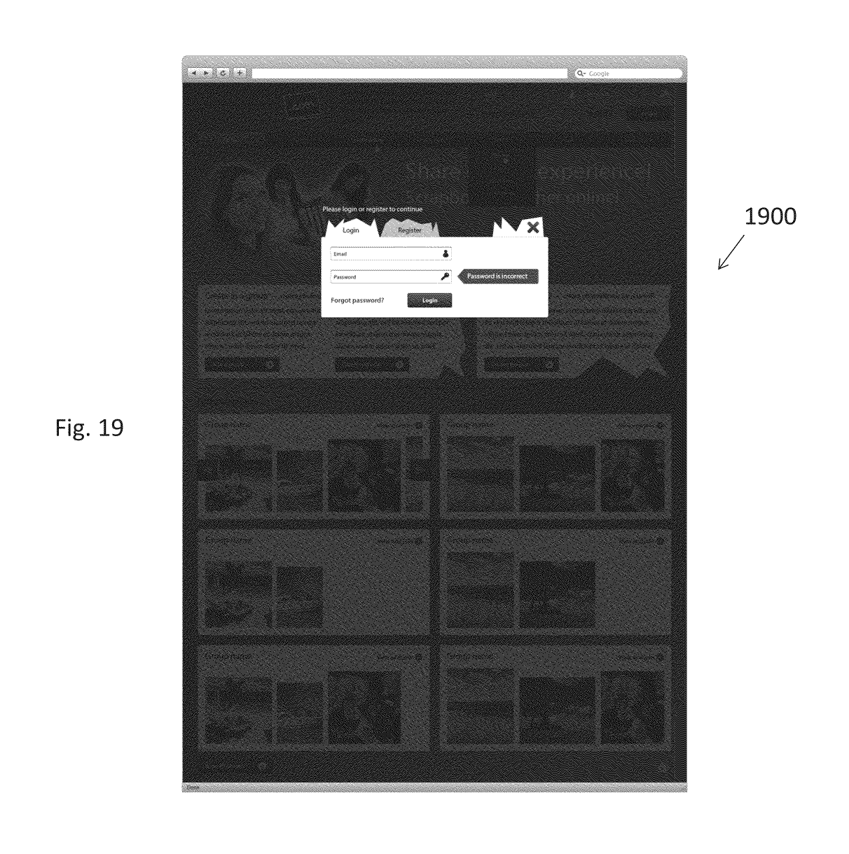

FIG. 19 illustrates an example display screen 1900 for how a User first registers or accesses their User account with the Project Manager.

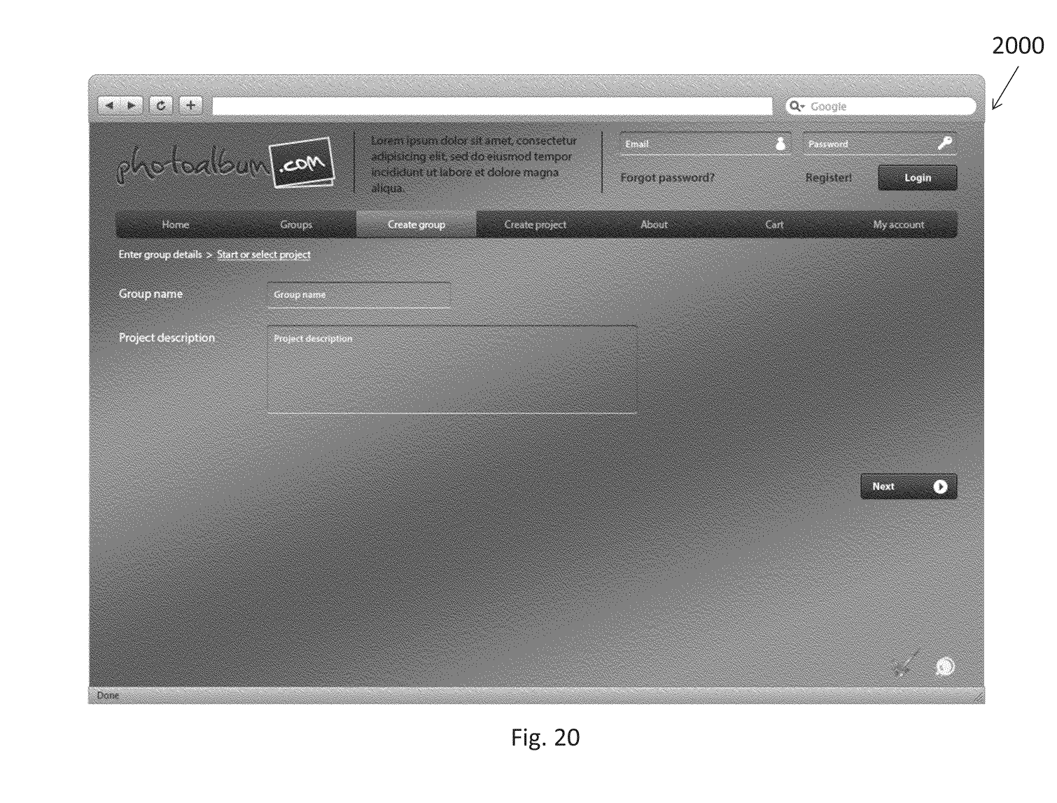

FIG. 20 illustrates an example display screen 2000 for how a User accesses the Social Networking Manager for the purpose of Creating a new Micro Network Group.

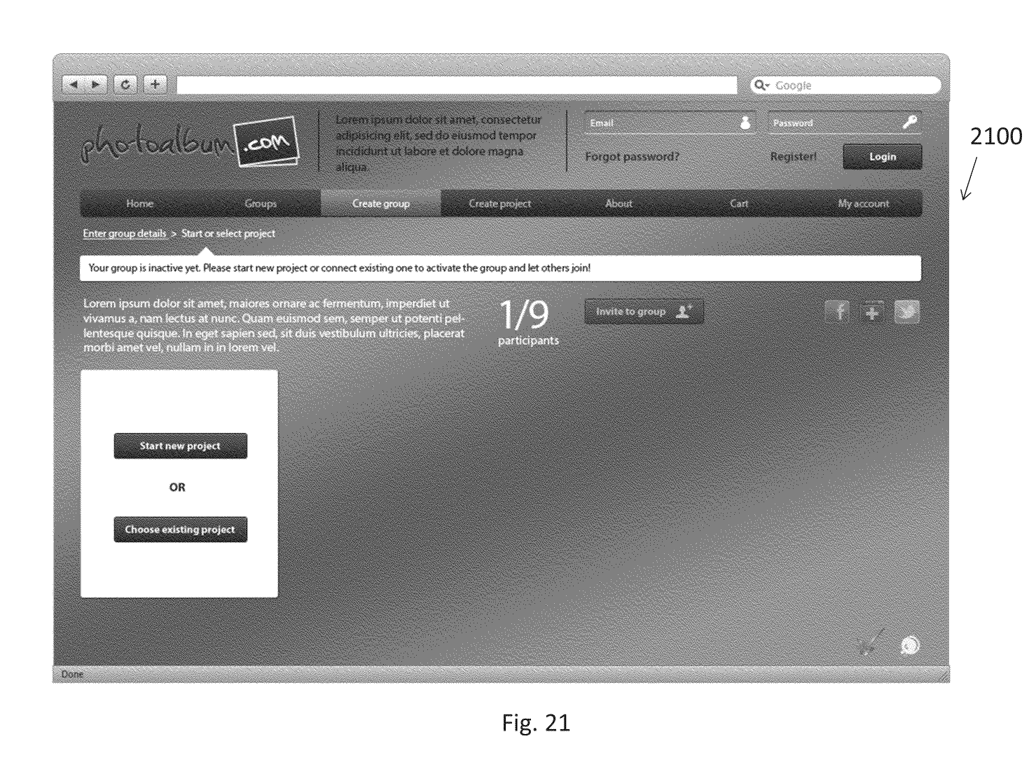

FIG. 21 illustrates an example display screen 2100 for how the Social Networking Manager interfaces with the Project Manager to insure that a proper and valid Design Project is either created or selected to attach to the newly created Micro Network Group.

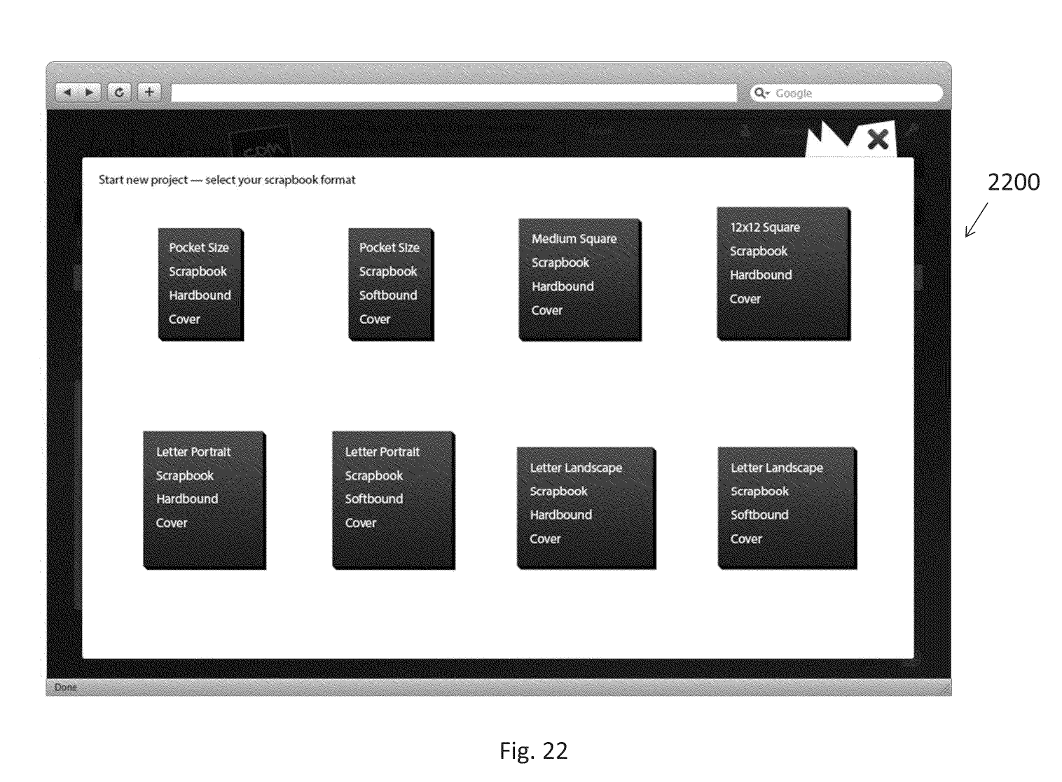

FIG. 22 illustrates an example display screen 2200 for how the Project Manager is used to display various Project/Product offerings to enable Users to create new Design Projects based on the designable product and components.

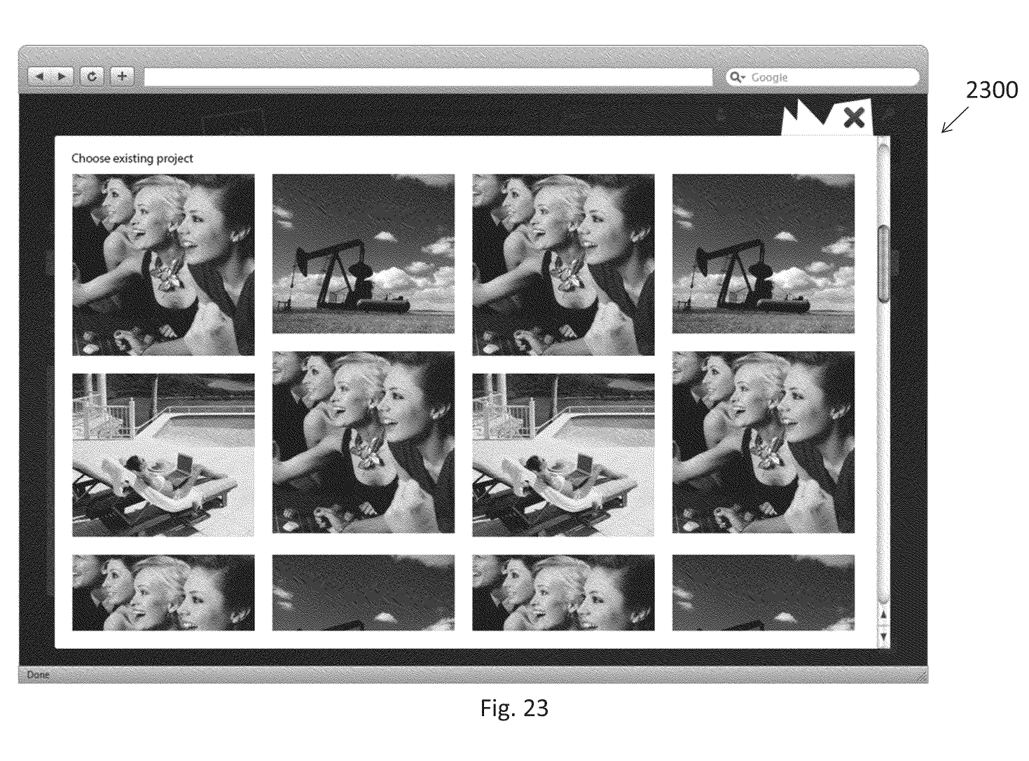

FIG. 23 illustrates an example display screen 2300 for how the Project Manager enables Users to select specific Design Projects for inclusion to a specific Micro Network Group. Design previews are created using the Design Processors.

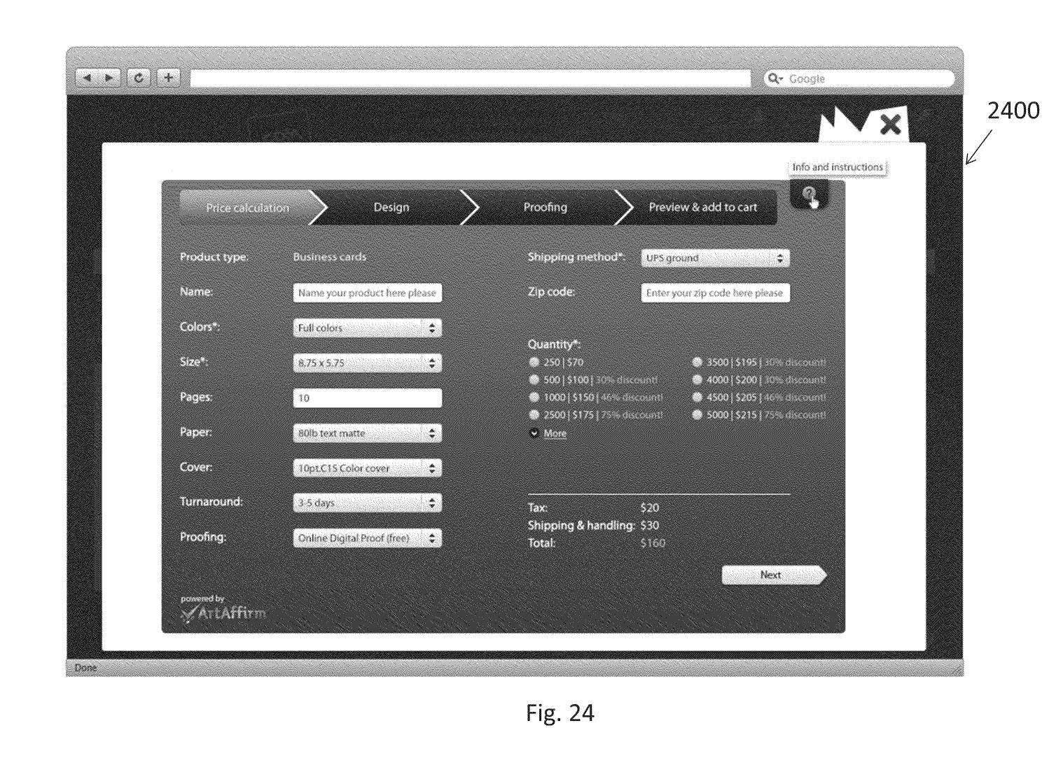

FIG. 24 illustrates an example display screen 2400 for how the Project Manager provides options to enable the User to manage the options which control the Product and sub-component options.

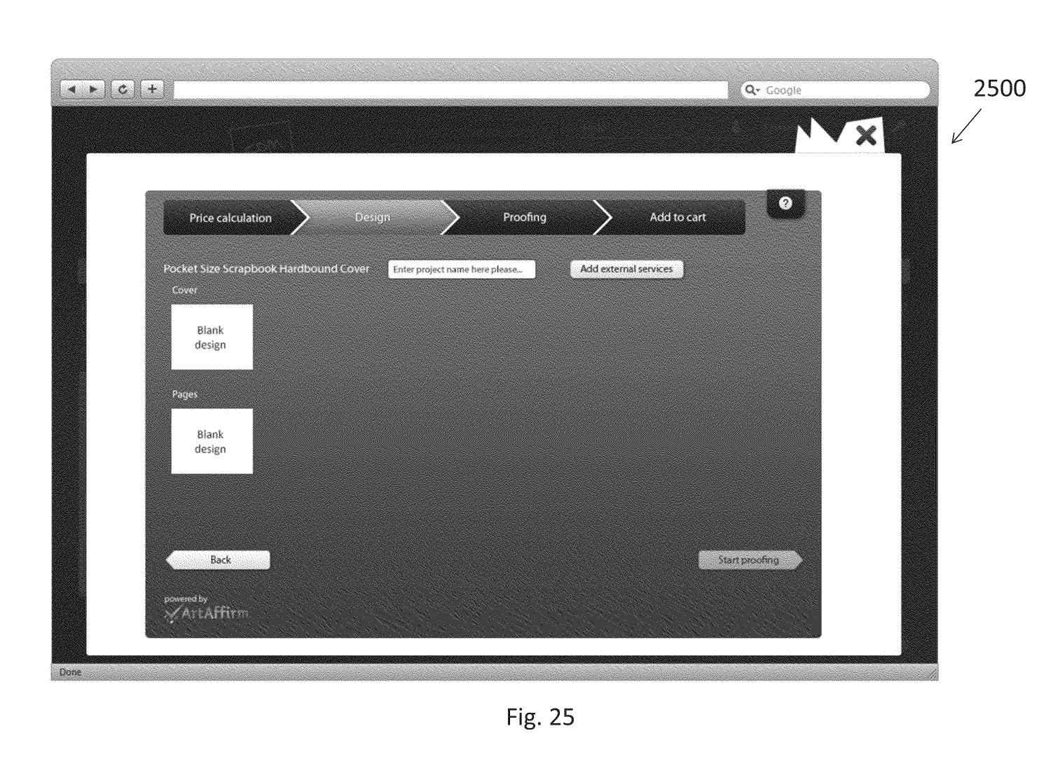

FIG. 25 illustrates an example display screen 2500 for how the Project Manager enables the User to access the Design Studio for each Project Component.

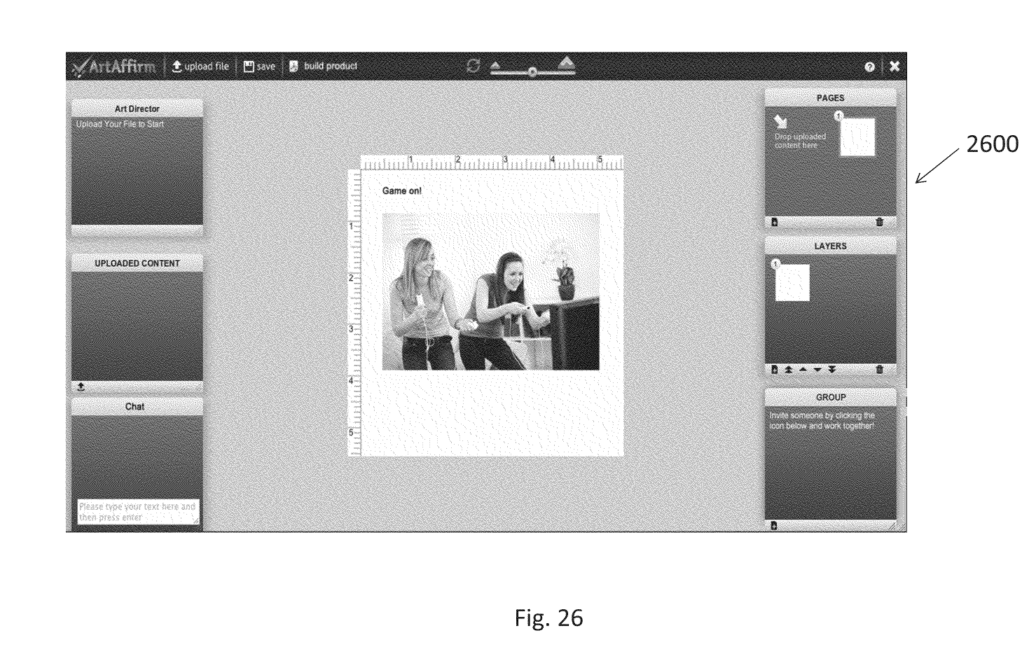

FIG. 26 illustrates an example display screen 2600 for the Design Studio for creating project designs. The Design Studio allows Users to upload various artwork elements in a broad range of formats and to drag and drop these into the page Layout area for the specific product component. Artwork and text elements can be transformed according to scale, position, and layering relative to other elements. Depending on the sub component requirements users can create single or multi-page designs. When complete these online designs can be converted to other formats such as a print ready PDF.

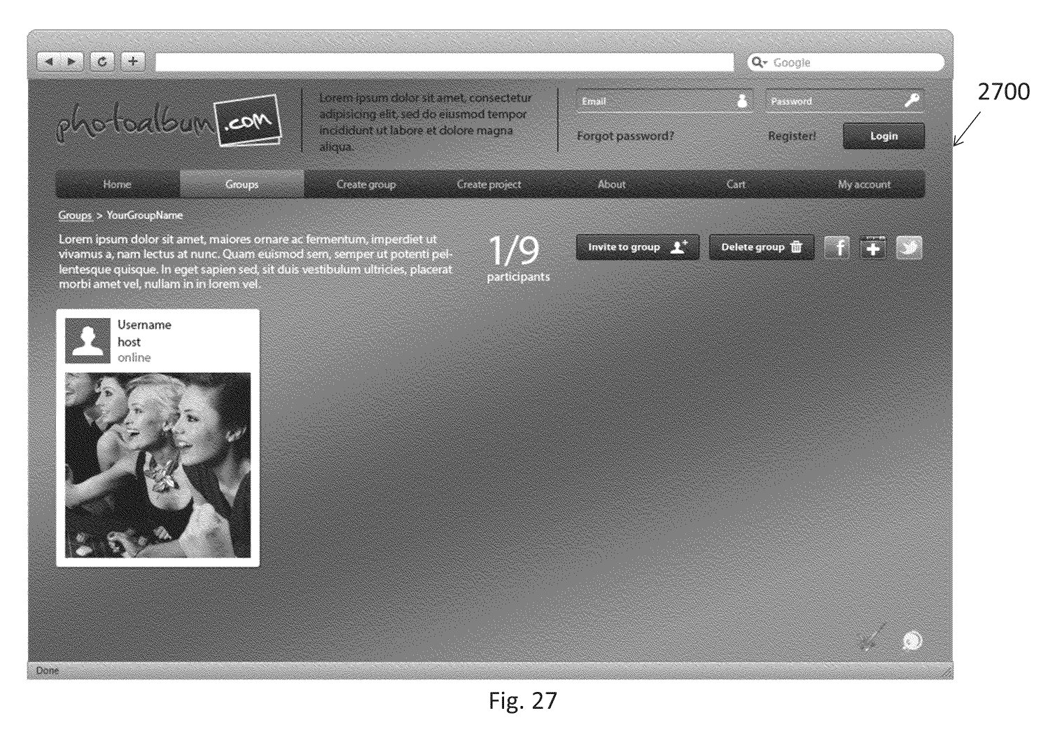

FIG. 27 illustrates an example display screen 2700 for the relationship between Design Projects and Groups. The Collaboration Manager in-conjunction with the Design Processors prepares the Design Previews for Design Projects. These saved designs can then be attached to Micro Network Groups using the Social Networking Manager. These Groups can then be expanded using the Invite options or can be completely disbanded using the Delete option, thus enabling these Micro Network Groups to quickly form and disappear when no longer needed. This creates more value due to urgency attached to such short lived connections.

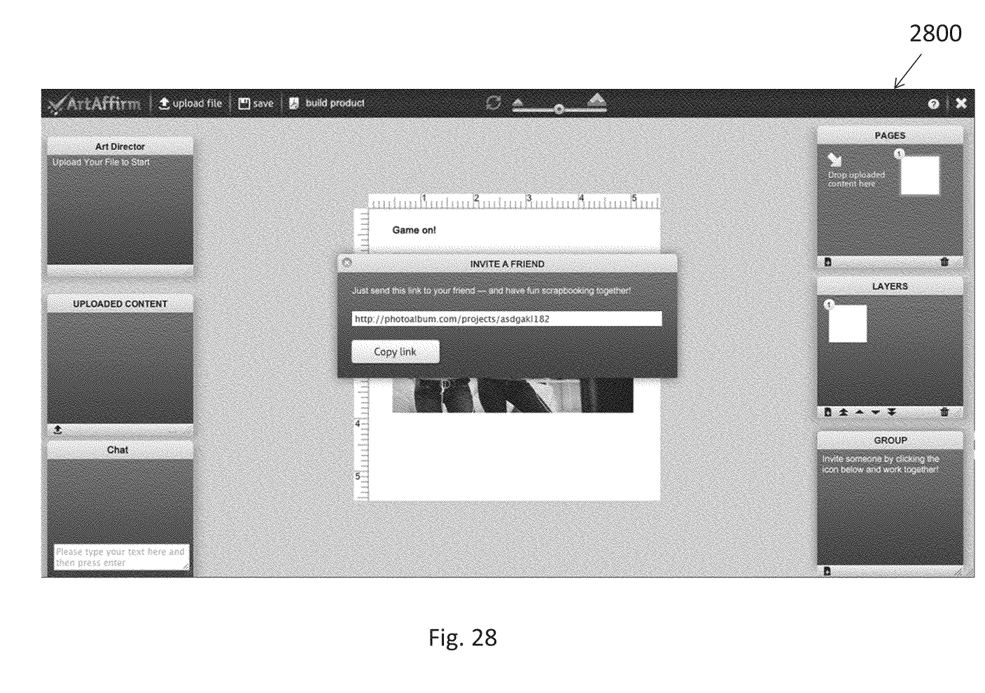

FIG. 28 illustrates an example an example display screen 2800 of creating a group, a project, and then inviting to the live project while it is in progress. This example might be completely disbanded once the user leaves this one instance of Design Studio usage.

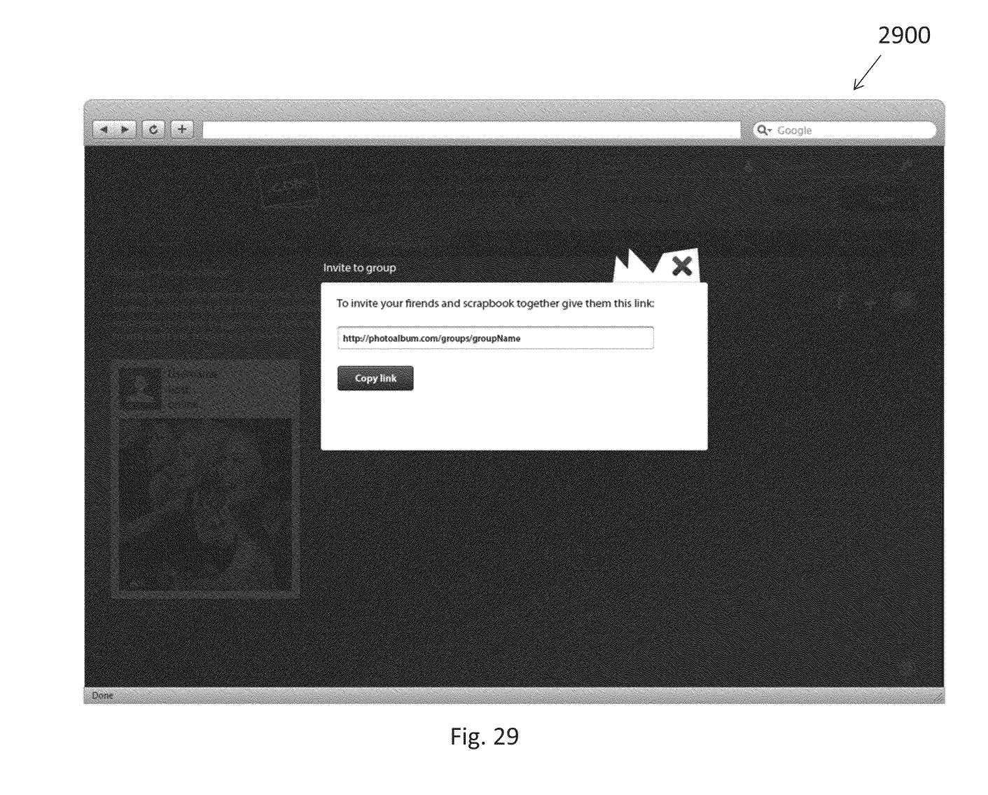

FIG. 29 illustrates an example display screen 2900 where a Micro Network Group might be created using the direct Social Networking Manager for the purpose of a slightly longer existence.

Using MSCDS for Site Moderation

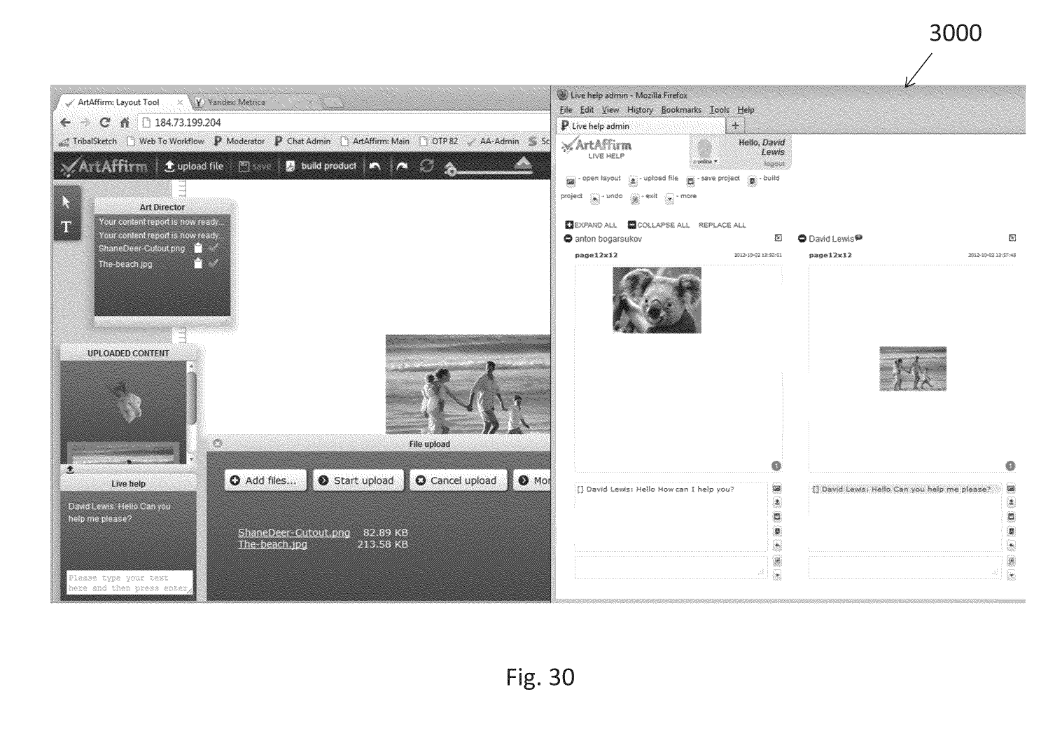

FIG. 30 illustrates an example display screen 3000 for using MSCDS to monitor Design Studio usage and to provide live human interaction. In this example the window on the left shows an example of a User working with Design Studio which is then connected to the Collaboration Manager. The Window on the right side is then connected to the Social Networking Manager through an administrative access. This “Administrative View” allows this user to moderate all uses of the Design Studio. As each user makes changes using the Design Studio, these changes are transmitted to the Collaboration Manager which then produces an updated Design Preview using the Design Processors. These Design Change Previews are then transmitted to the special Moderator panel using the Collaboration Manager and displayed in the Moderator window. The Moderator window can use the Collaboration Manager to transmit both standard communication “Chat” messages, as well as actual Design Studio commands such as Upload, Save, Build, Undo and much more.

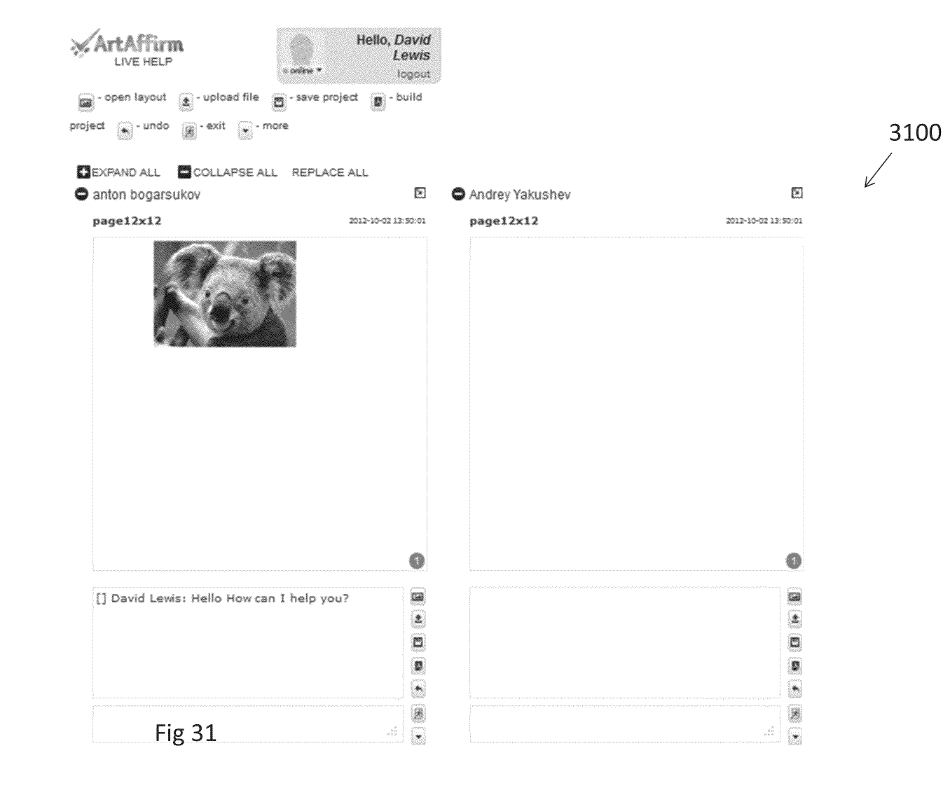

FIG. 31 shows an example display screen 3100 for an enlarged view of the moderator panel where moderators can see product selection, current page number, date-time, live preview, chat history, and Design Studio command access buttons.

Although the present application has been described in relation to particular embodiments thereof, many other variations and modifications and other uses will become apparent to those skilled in the art. It is preferred, therefore, that the present application not be limited by the specific disclosure herein.

What is claimed:

1. A method for providing on-line micro-social collaboration for a plurality of users of computing devices, the method comprising:
storing, on processor readable media accessible to at least one processor, one or more databases that include:
electronic user information representing users registered to participate in the micro-social collaboration; and
electronic project information representing a plurality of projects created and/or edited by at least some of the registered users, each of the projects including at least one respective page description;
receiving, over a communication network from a first of a plurality of respective computing devices operated by a first of the registered users, a first request to access a first of the projects;
receiving, over the communication network from a second of a plurality of respective computing devices operated by a second of the registered users, a second request to access a second of the projects;
processing, by at least one processor, each of the first and second requests to provide current representations of the first and second projects to the first and second computing devices, respectively, and to provide a communication connection for the users of the first and second computing devices to communicate with each other;
receiving, from the first computing device accessing the first project, an editing change to the first project;
processing, by at least one processor, the received editing change to modify at least a portion of at least one respective page description of the first project, thereby revising the first project in accordance with the editing change, and to update the representation of the first project; and
transmitting, to each of the first and second computing devices, the updated representation of the first project.

2. The method of claim 1, further comprising:
receiving, from one of the first and second computing devices, a message directed to the user of the other of the first and second computing device; and
transmitting, to the other of the first and second computing devices, the message.

3. The method of claim 2, wherein the message is formatted as text, audio and/or video.

4. The method of claim 1, further comprising:
receiving, from a third computing device accessing the second project, an editing change to the second project;
processing, by at least one processor, the received editing change from the third computing device to modify at least a portion of at least one respective page description of the second project, thereby revising the second project, and to update the representation of the second project; and
transmitting, to the first, second and third computing devices, the updated representation of the second project.

5. The method of claim 1, further comprising:
receiving from a third computing device operated by a registered user, an instruction to create a new project;
receiving requests to access the new project, over a communication network from each of a plurality of respective computing devices operated by at least some of the registered users;
processing, by at least one processor, each of the requests to provide a current representation of the new project to each of the respective computing devices and to provide a communication connection for at least two of the users of the respective computing devices that are accessing the group projects to communicate with each other.

6. The method of claim 5, further comprising storing, in the one or more databases, a plurality of respective project template files that are usable to form new projects, and wherein the new project is based on a project template file.

7. The method of claim 1, wherein the editing change includes new graphical content provided by the one of the respective computing devices.

8. The method of claim 7, further comprising:
formatting, by at least one processor, the received new graphical content to comply with one or more of layout, size and resolution in accordance with the project, and wherein the processing the received editing change includes updating the representation of the project to include the new graphical content.

9. The method of claim 8, wherein the graphical content includes an image and/or a video.

10. The method of claim 1, further comprising representing one of the first user and the second user devices as a manager of the first or second project, respectively.

11. The method of claim 10, further comprising:
receiving, from the manager an instruction to close the respective project; and
processing the instruction to close the respective project by preventing access to the project by any computing device operated by any of the registered users and by terminating the communication connection for the at least two of the users of the respective computing devices associated with the second project.

12. The method of claim 1, wherein each of the requests is received over a web group socket channel.

13. The method of claim 1, further comprising:
providing, by at least one processor, the first project or the second project to at least one of the respective computing devices in a single window having a plurality of panes, wherein at least some of the panes include respective real-time representations of at least some of the other users.

14. The method of claim 1, wherein the first and second projects are the same project.

15. The method of claim 1, further comprising tagging the project with one or more of a:
a project identifier;
a user identifier;
a page layout description;
an identifier of a recently edited page; and
a preview image of each page of the project.

16. The method of claim 1, further comprising:
identifying, by at least one processor, at least one of the projects represented in the one or more databases that has been edited; and
accessing the at least one edited project.

17. The method of claim 1, further comprising:
storing a plurality of respective designs for each of a plurality of the projects represented in the one or more databases; and
providing one of the respective designs of the project to one of the respective computing devices; and
providing one other of the respective designs of the project to one other of the respective computing devices.

18. The method of claim 1, further comprising tracking, by at least one processor, the status of each respective computing device associated with the plurality of registered users, wherein the status represents at least whether the computing device is logged in.

19. A system for providing on-line micro-social collaboration for a plurality of users of computing devices, the system comprising:
one or more processor readable media;
one or more processors operatively coupled to the one or more processor readable media;
the one or more processor readable media further have instructions for causing the following steps to be performed by the one or more processors:
store, on processor readable media accessible to at least one processor, one or more databases that include:
electronic user information representing users registered to participate in the micro-social collaboration; and
electronic project information representing a plurality of projects created and/or edited by at least some of the registered users, each of the projects including at least one respective page description;
receive, over a communication network from a first of a plurality of respective computing devices operated by a first of the registered users, a first request to access a first of the projects;
receive, over the communication network from a second of a plurality of respective computing devices operated by a second of the registered users, a second request to access a second of the projects;
process, by at least one processor, each of the first and second requests to provide current representations of the first and second projects to the first and second computing devices, respectively, and to provide a communication connection for the users of the first and second computing devices to communicate with each other;
receive, from the first computing devices accessing the first project, an editing change to the first project;
process, by at least one processor, the received editing change to modify at least a portion of the respective page description of the first project, thereby revising the first project in accordance with the editing change, and to update the representation of the first project; and
transmit, to each of the first and second computing devices, the updated representation of the first project.

20. A system for providing on-line micro-social collaboration for a plurality of users of computing devices, the system comprising:
a collaborative manager that is configured to automatically incorporate edits made by a plurality of computing devices into a project, and display a preview of at least some of the project to each of the plurality of computing devices, wherein the collaborative manager is configured to include:
a project manager;
a design manager,
a rendering engine,
a preview manager,
a storage interfacing module,
a project database, and
an account database.
